(19) United States
(12) Patent Application Publication
(10) Pub. No.: US 2008/0133306 A1
(43) Pub. Date: Jun. 5, 2008

(54) SYSTEM AND METHOD FOR ASSISTING INDIVIDUALS TO GENERAL CONTRACT A HOME

(75) Inventor: James Stirlen, Eden Prairie, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: President Homes, Inc., New Hope, MN (US)

(21) Appl. No.: 11/848,254

(22) Filed: Aug. 31, 2007

Related U.S. Application Data
(60) Provisional application No. 60/824,164, filed on Aug. 31, 2006.

(51) Int. Cl. G06Q 10/00; G06Q 40/00

(52) U.S. Cl. 705/9; 705/35; 705/30

(57) ABSTRACT

A method for assisting individuals in general contracting the construction of a home. The method includes providing a computer program remotely accessible by users over a computer network through which the individual desiring to build the home can access databases comprising a pool of Providers of services and materials from the geographic area in which the home is to be built and upon which the individual can rely for constructing a home pursuant to a Build Plan. A Budget Manager and Scheduling Manager is available to enable the individual to manage the budget and schedule the Build Plan.

### CROSS REFERENCE TO RELATED APPLICATIONS

This application claims the benefit of and priority to U.S. Provisional Application No. 60/824,164 filed Aug. 31, 2006.

### BACKGROUND OF THE INVENTION

Often, individual homeowners wish to act as their own general contractors for the construction of their home because doing so can result in substantial cost savings which, in turn, can produce immediate home equity. However, few homeowners have the knowledge or experience of home construction practices necessary to general contract their home. Furthermore, even those that have the necessary knowledge often do not have the experience needed to organize and schedule all the tasks associated with home construction in order to successfully complete such a project on time and within budget.

Although a home owner may attempt to rely on commercially available construction planning and schedule management software programs (hereinafter collectively “construction planning programs”) to help him/her plan, organize and schedule the construction operations, the Subcontractors, equipment and other resources, it is generally not practical for an individual homeowner to purchase a commercially available construction planning program due to cost and the time required to learn and become proficient with the program—particularly when, in all likelihood, the homeowner would only utilize the construction planner once in his/her lifetime. Accordingly there is a need for an affordable and relatively easy to operate construction planning program for access and use by individual homeowners to assist them in general contracting of a home.

It should be appreciated, however, that a construction planning program is only useful in planning and organizing the construction and coordinating Subcontractors. It is of little benefit in locating experienced and reputable Subcontractors that can actually do the work to be scheduled. While a homeowner may be able to compile a list of names of Subcontractors by selecting names from a yellow page directory, by compiling advertisements, or by talking with friends and neighbors, such efforts are time consuming. With such methods, there is really no way for the homeowner to know that the Subcontractor will provide quality workmanship or that the Subcontractor can reliably complete a project on budget and on time. Generally, the only way one can have reasonable assurance that he/she is dealing with a reputable Subcontractor or provider is to rely on those that have personal experience working with the Subcontractor or provider. Accordingly, there is a need for a system and method which provides the homeowner with a pool of reputable and experienced Subcontractors from which to choose for subcontracting the actual construction of the home.

Likewise, there is a need for a system and method which also provides the homeowner with a pool of names of other product and service providers from which to choose throughout all phases of the home design, planning, financing and construction, including, for example, reputable building material Suppliers, reputable Lenders from which to secure construction financing for an owner-involved project, and reputable Realtors/Developers to assist the homeowner in locating available land on which to build.

Furthermore, even with a pool of names of reputable product and service providers and even with an easy to use construction planning software program at the homeowner's disposal, unless there is an available source of knowledge and experience upon which the homeowner can rely to ask questions and obtain advice, homeowners who have little or no experience general contracting a home may still feel too intimidated or overwhelmed with the scope of the project to undertake the general contracting of a home. Accordingly, there is a need for a system and a method that can provide knowledgeable and experienced individuals to assist the homeowner throughout all phases of the home planning, financing and construction process.

### BRIEF DESCRIPTION OF THE DRAWINGS

FIG. 1 is a schematic representation of an embodiment of the system and method of the present invention.

FIG. 2 is a flowchart identifying various stages of the preferred system and method of the present invention.

FIG. 3 is a more detailed flowchart identifying additional stages of the preferred system and method of the present invention.

FIGS. 4A-4B show a sample preferred “Contact Page” for use with the preferred system and method of the present invention.

FIG. 5 is a sample Initial Lead email generated in response to submission of the Contact Page of FIGS. 4A-4B.

FIGS. 6A-6B show a sample Contact Information template for use with the system and method of the present invention.

FIGS. 7A-7B show a sample Sales Rep page for use with the system and method of the present invention.

FIG. 8 is a sample Sales Rep Lead page for use with the system and method of the present invention.

FIGS. 9A-9B show a sample Pre-Qual page for use with the system and method of the present invention.

FIG. 10 is a sample Pre-Qualification Form for use with the system and method of the present invention.

FIGS. 11A-11E show a sample Prospect Cost-to-Build (CTB) Page for use with the system and method of the present invention.

FIGS. 12A-12B show a sample Add CTB Item page for adding items to the CTB Page of FIGS. 11A-11E.

FIGS. 13A-13E show a sample Remove CTB Item page for removing items to the CTB Page of FIGS. 11A-11E.

FIG. 14 is a sample Prospect Financial Summary page for use with the system and method of the present invention.

FIG. 15 is a sample Customer Financial Summary page for the preferred Budget Manager.

FIG. 16 is a sample Customer CTB page for the preferred Budget Manager.

FIGS. 17A-17C show a sample Customer Bids page for the preferred Budget Manager.

FIG. 18 is a sample Subcontractor page for use with the Customer Bids page of FIG. 17.

FIG. 19 is a sample Subcontractor Contact page for use with the Subcontractor page of FIG. 18.

FIGS. 20A-20B show a sample Loan Page for the preferred Budget Manager.

FIGS. 21A-21B show a sample Invoice Page for the preferred Budget Manager.

FIG. 22 is a sample Add Invoice page for use with the Invoice Page of FIGS. 21A-21B.

FIGS. 23A-23B show a sample Draw Page for the preferred Budget Manager.

FIG. 24 is a sample Draw Template for use with the Draw Page of FIGS. 23A-23B.

FIGS. 25A-25B show a sample Payment Page for the preferred Budget Manager.

FIGS. 26A-26F show a sample Schedule Manager Page for the Build Manager.

FIGS. 27A-27S show a sample Schedule & Activities Page for the Build Manager.

FIG. 28 is a sample Inspection Page for the Build Manager.

FIG. 29 is a sample Inspection Task Template for the use with the Inspection Page of FIG. 28.

FIG. 30 is a sample Land Document Page for the Build Manager.

### DETAILED DESCRIPTION OF THE INVENTION

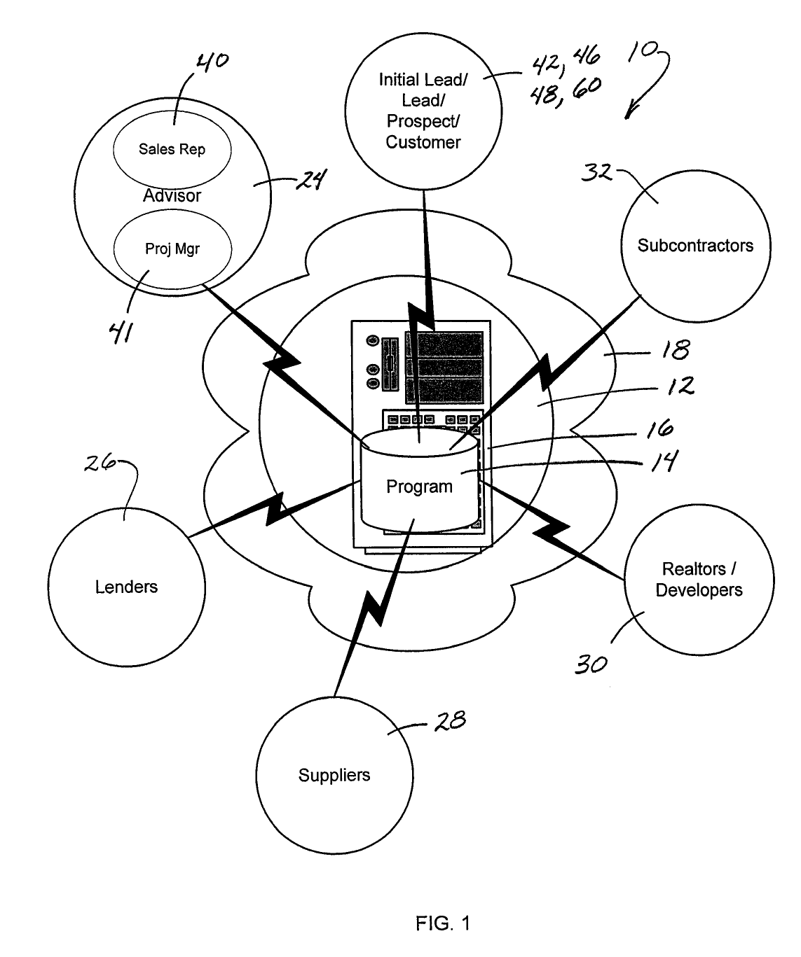

Referring now to the drawings wherein like reference numerals are used to designate corresponding parts or features throughout the several views, FIG. 1 illustrates one embodiment of the construction planner system and method of the present invention, designated generally by reference numeral 10, to assist a person with the general contracting of a home.

In the preferred system and method, an application service provider (ASP) 12 supports and maintains a computer software program that provides certain features and functionalities described later and which includes or interfaces with one or more databases (collectively, hereinafter the “Program” 14). In addition to supporting and maintaining the Program 14, the ASP 12 also preferably provides guidance and assistance to the individual desiring to general contract his/her own home from the initial contact stage through the completion of the home construction. The Program 14 is preferably supported and maintained by the ASP 12 on a computer server 16 that is preferably remotely accessible over a computer network, such as the Internet. In the preferred system and method, the Program 14 is a web-based application accessible a conventional web-browser such as Internet Explorer or Netscape. However, the main features and functionalities of the Program 14 are only made available to users who are authorized by the ASP 12, such as customers and other providers of goods or services (all discussed later).

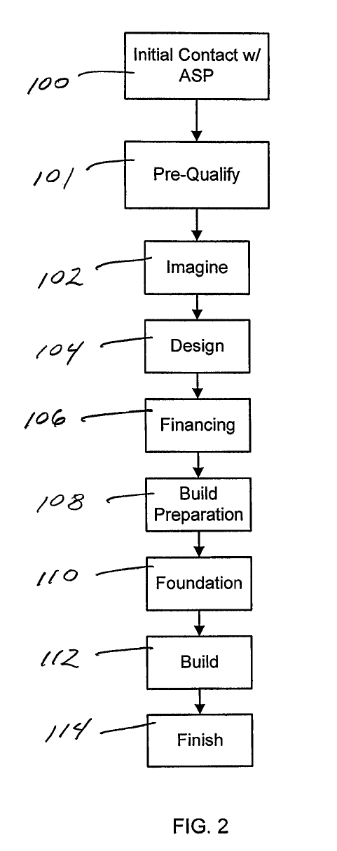

FIG. 2 identifies nine stages comprising the preferred embodiment of the system and method 10 of the present invention. Obviously more or fewer stages could be utilized and it should be appreciated that the tasks and activities associated with a particular stage may vary and may occur concurrently as opposed to sequentially as illustrated for simplicity in FIG. 2. The first stage is designated as the Initial Contact Stage 100, which is followed by the Pre-Qualification Stage 101, then the Imagine Stage 102, then the Design Stage 104, then the Financing Stage 106, then the Build Preparation Stage 108, followed by the Foundation Stage 110, then the Build Stage 112, and finally the Finish Stage 114. Each of these stages will be discussed in greater detail later.

Referring back to FIG. 1, throughout the various stages 100-114 of the system and method 10, various users may have access to and use of at least some of the features and functionalities of the Program 14, including Advisors 24, Lenders 26, Suppliers 28, Realtors/Developers 30 and Subcontractors 32 (collectively referred to hereinafter as “Providers”).

The Advisors 24 are preferably individuals sufficiently experienced in home construction planning and scheduling so as to be able to guide and assist the prospective customer throughout all the various stages of the home construction project. The Advisors 24 may be employees of the ASP or independent contractors to the ASP. In the preferred embodiment, the Advisors 24 may include Sales Representatives 40 (hereafter “Sales Reps”) knowledgeable with the various tasks and activities associated with the stages of the home construction preferably up through at least the Build Preparation stage 108. The Advisors 24 may also include project managers or construction managers 41 who are familiar with the various tasks and activities associated with the Build Preparation stage 108, Foundation stage 110, Build stage 112 and the Finish stage 114.

The Lenders 26 are preferably licensed in the state in which the prospective customer resides, who have experience in owner-involved construction financing, and who can provide competitive quotes. The Lenders 26 may include national or local mortgage brokers. It is preferable that the Lenders 26 also have the appropriate network of appraisers, title searchers, and other individuals necessary to close the construction financing for the prospective customer if and when the need arises.

The Suppliers 28 preferably include companies that supply the materials and equipment necessary for the construction of a home, including, without limitation, concrete or other foundation materials, lumber and other framing materials, piping and plumbing fixtures, electrical and electric fixtures, heating ventilation and air conditioning (HVAC) materials and fixtures, sheet rock or other interior wall materials, exterior wall materials, roofing materials, paint, insulation, flooring, trim and other millwork, and interior furnishings.

The Realtors/Developers 30 are preferably individual real estate agents, brokers or real estate developers located in the geographic area in which the home is to be built, or who are at least familiar with the housing market in the geographic area in which the home is to be built such that the Realtors/Developers 30 can locate and/or advise the prospective customer on available land for sale in the geographic area where the prospective customer desires to build.

The Subcontractors 32 are preferably companies or individuals located within the general area or region in which the home is to be built, and who are experienced in a particular home construction trade, such as for example, architecture, excavation, foundation work, framing, electrical work, insulation work, dry walling, shingling, finish carpentry, painting, tiling, carpeting and other flooring installation, landscaping and site work, and interior design.

Under the preferred system and method, the ASP 12 preferably “partners” with the Providers in order to secure for the prospective customer a network of stable and reputable vendors of products and services from which the customer can call upon for obtaining competitive bids for services and cost savings for products or services. For example, in addition to the Providers identified above, other Providers may include appliance manufactures that partner with the ASP 12 to offer discounts to its homeowner/customer base. Likewise, a national or local wholesaler for floor coverings, for example, may vie to be included as one of the ASP's network of Providers. In order to facilitate the “partner” network of vendors, the ASP 12 may include links to the Provider's website for order of products, requesting bids, etc. Furthermore, the ASP Program 14 may automatically save links to on-line order forms or receipts from Providers to enable the customer to check on the status of the orders and/or to import the dollar amount of the order into the customer's budget (discussed later).

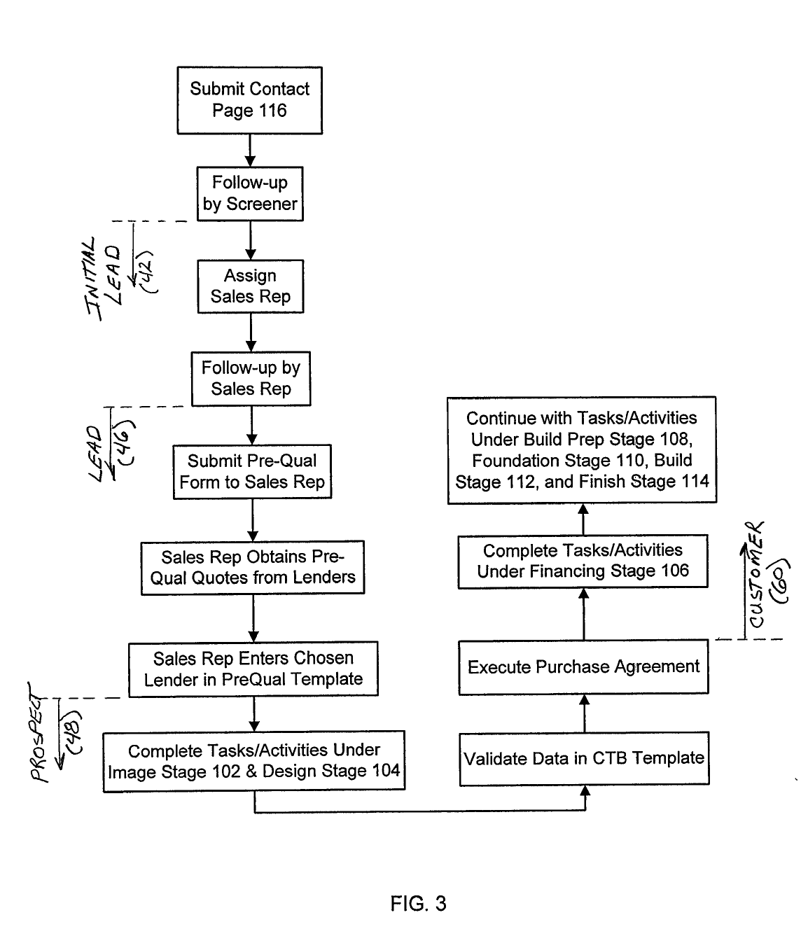

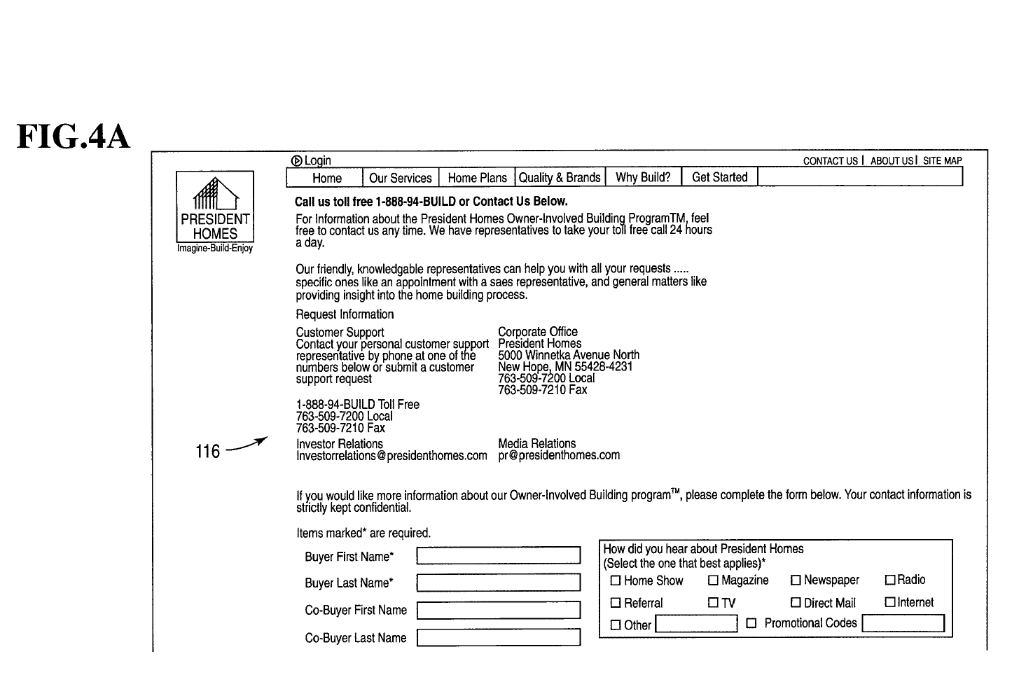

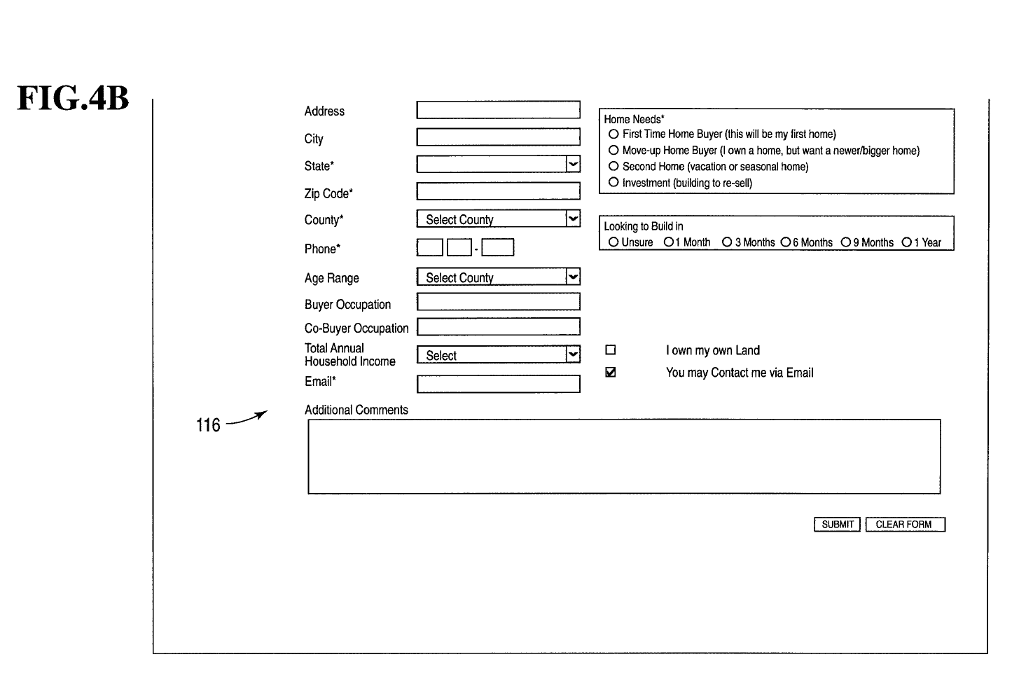

Referring to FIGS. 2 and 3, the system and method 10 of the present invention, is commenced when an individual initiates contact with the ASP 12. This initial contact 100 may be commenced by the individual contacting the ASP 12 through a call center or, preferably, by the individual visiting the ASP's website and select a “contact us” link or similar link which opens a webpage within which the individual can input initial contact information and request a follow-up by an Advisor 24, such as a Sales Rep 40. An example of a preferred webpage Contact Page 116 is illustrated in FIGS. 4A and 4B. The contact information may include the individual's name, current address, telephone numbers, and email address as well as information such as the individual's age, occupation, income, co-buyer information (if applicable), home needs, and a time frame in which the individual is interested in beginning construction.

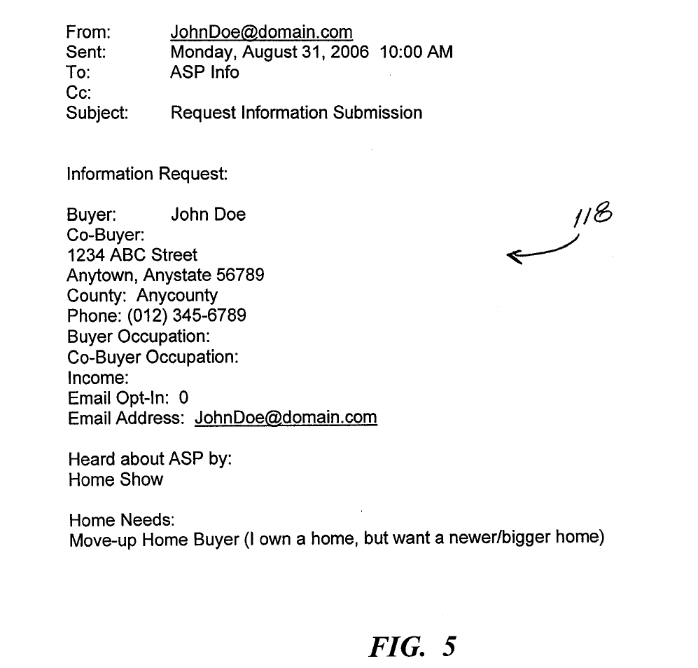

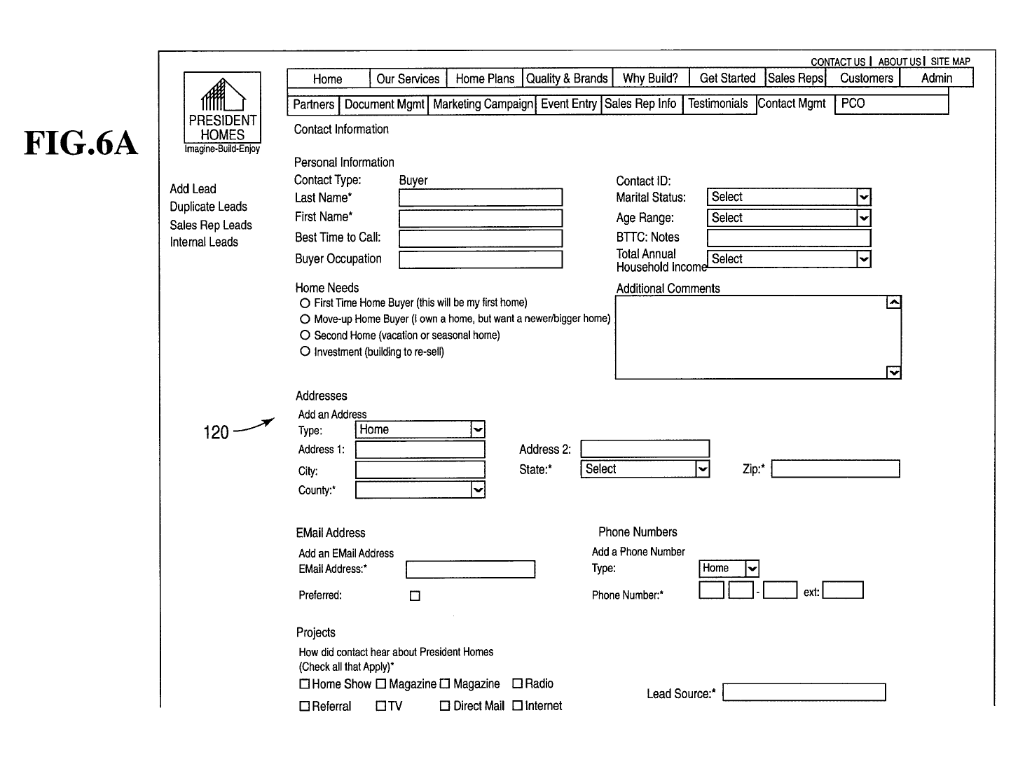

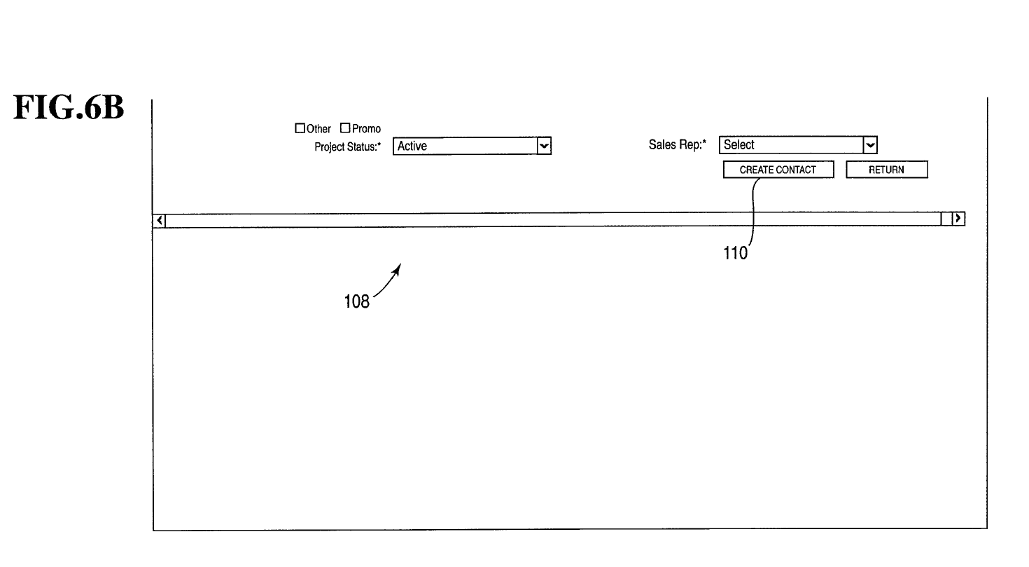

Preferably, upon clicking the “submit” button 118 on the Contact Page 116 (FIG. 4B), the entered data is uploaded to the Program 14 and the interested individual becomes an “Initial Lead” 42. Upon the uploading of the Initial Lead data, the Program 14 also preferably generates an email 118 (FIG. 5) to a designated screener or other representative of the ASP 12 for follow-up. The generated email 118 preferably includes the contact data entered by the Initial Lead 42 through the Contact Page 116. The screener preferably contacts the Initial Lead 42 by calling or emailing the Initial Lead 42 using the contact information displayed in the email message 118. As illustrated in FIGS. 6A-6B, the Program 14 preferably includes a “Contact Information” template 120 which the screener uses when contacting the Initial Lead 42. The Contact Information template 120 is preferably populated with the Initial Lead data by pulling that data stored in the Program 14 when the screener opens the Initial Lead email 118 from the screener's email in-box. During verbal or email correspondence with the Initial Lead 42, the screener preferably verifies and fills in any blank fields within the Contract Information template 120.

It should be appreciated that if the individual's initial contact with the ASP is through a call center, the call center may utilize the Contact Information template 120 to enter the interested individual's data, at which point the individual would then become an “Initial Lead.”

After the screener verifies and fills in all blank fields in the Contact Information template 120, the screener preferably clicks the “create contact” button 110 on the Contact Information Template 120. Next a Sales Rep 40 is assigned and associated with the Initial Lead 42. This Sales Rep assignment step 122 is preferably performed automatically by the Program 14 based upon predefined criteria. Alternatively, the screener may perform the Sales Rep assignment step 112 by manually selecting a Sales Rep 40 from a drop down list within the template 120.

In the preferred system and method, the ASP 12 will have previously retained employees or independent contractors to comprise the pool of available Sales Reps from which the Program 14 and/or screener chooses when making the assignment. The predefined criteria upon which the Program 14 bases its selection of the Sales Rep 40 may be by geographic location. For example, a Sales Rep 40 may be assigned all Initial Leads 42 within a particular city, county or state. Alternatively, the predefined selection criteria may by based on load balancing among the pool of Sales Reps or any other form of allocation.

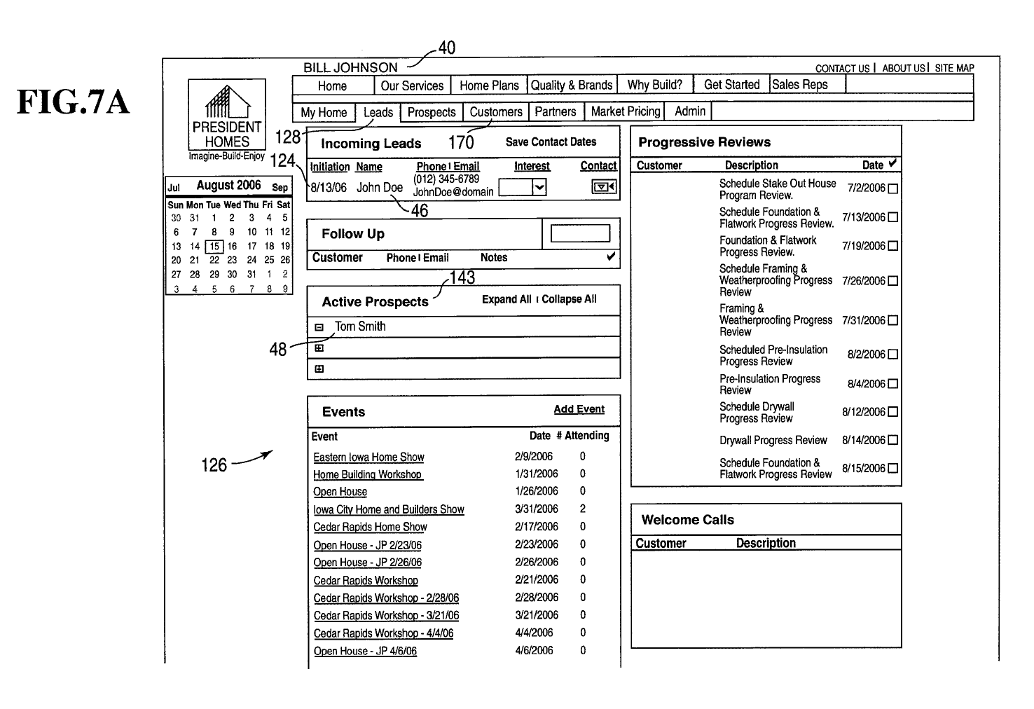

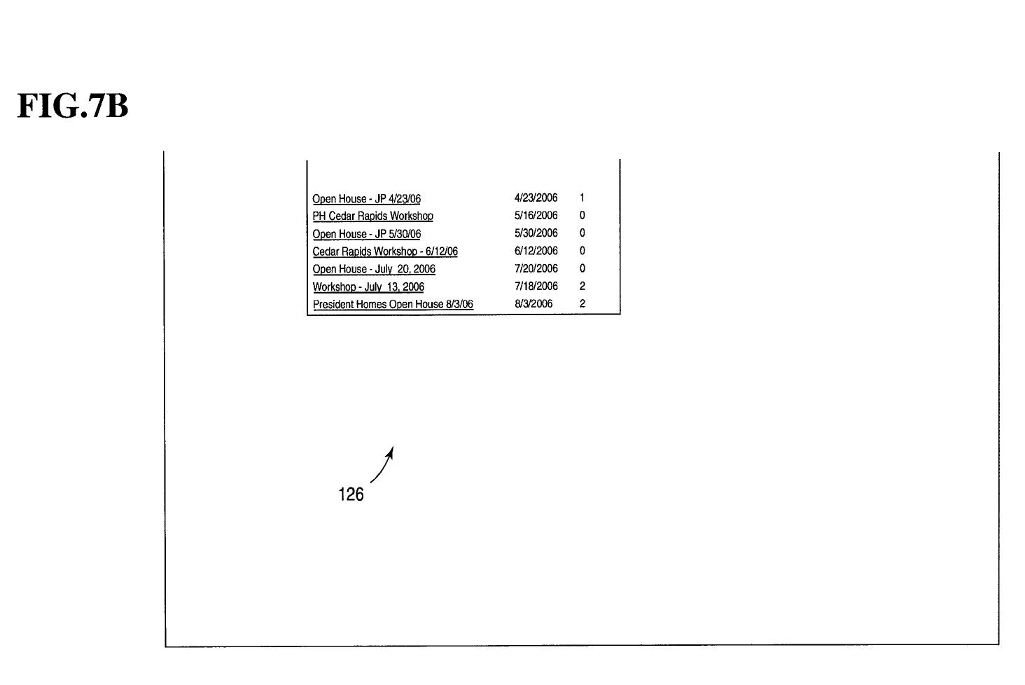

Upon assigning a Sales Rep 40, the Program 14 also preferably generates an email 124 (FIG. 7A) to the Sales Rep 40. Each Sales Rep 40 is preferably assigned a user ID and password by which it can access the Program 14. This username and password is preferably utilized to associate a “homepage” 126 to each Sales Rep 40, an example of which is illustrated in FIGS. 7A-7B. The email 124 generated by the Program 14 is preferably displayed on the Sales Rep's homepage 126 along with other information about upcoming events and other action items required to be performed by the Sales Rep 40.

Preferably the Program 14 monitors if the Sales Rep 40 opens the email 124. If the email 124 is not opened within a predetermined time period (for example, within forty eight hours), the email 124 changes to red or other distinct color to visually indicate to the Sales Rep 40 that the predetermined time period set for a follow-up contact of the Initial Lead 42 has expired. Referring to FIG. 7A, when the Sales Rep 40 contacts the Initial Lead 42, the Sales Rep 40 can preferably view the Initial Lead's contact information and other relevant information displayed through the same Contact Information template 120 (FIGS. 6A-6B) as previously discussed.

Preferably, one of the action items required of the Sales Rep 40 is to schedule a follow-up telephone appoint with the Initial Lead to move the process to the next stage. The Sales Rep 40 preferably has the ability to select a calendar through the Sales Rep's homepage 126 or on the Initial Contact Template 120 to schedule the follow-up appointment. Preferably upon the Sales Representative scheduling the follow-up appointment, the Program designates the Initial Lead 42 as a “Lead” 46. The Lead's name address and telephone number then preferably become viewable to the Sales Rep under the Leads tab 128 (FIG. 7A) accessible under the Sales Rep homepage 126.

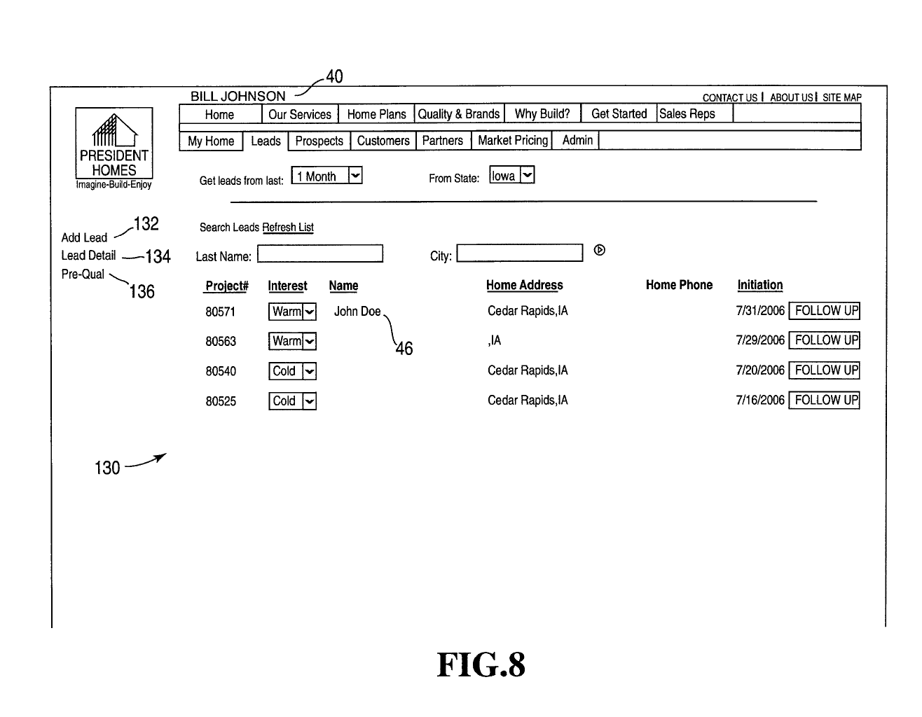

FIG. 8 illustrates an example of a sample Leads Page 130 displaying a Sales Rep's (Bill Johnson) current Leads 46. Thus, the former Initial Lead 42 (John Doe) is now a Lead 46 displayed on Bill Johnson's Leads page 130. On this page 130, the Sales Rep 40 can preferably specify the degree of interest of the Lead 46 by some indicator or designation, such as, for example hot, warm, cold. The filtering criteria by which the Leads 46 are displayed is also preferably selectable by a time period and by state or other geographic area. Within the Leads Page 130, the Sales Rep 40 can preferably select from among three side navigation tabs, including an “Add Lead” tab 132 by which the Sales Rep can add leads generated directly by that Sales Rep; a “Lead Detail” tab 134 for displaying detailed information about the Lead 46 similar to that displayed on the Contact Information Template 120 previously discussed; and a Pre-Qualification or “Pre-Qual” tab 136 through which the Sales Representative can enter quotes obtained from Lenders identifying the amount of financing for which the Lead 46 qualifies.

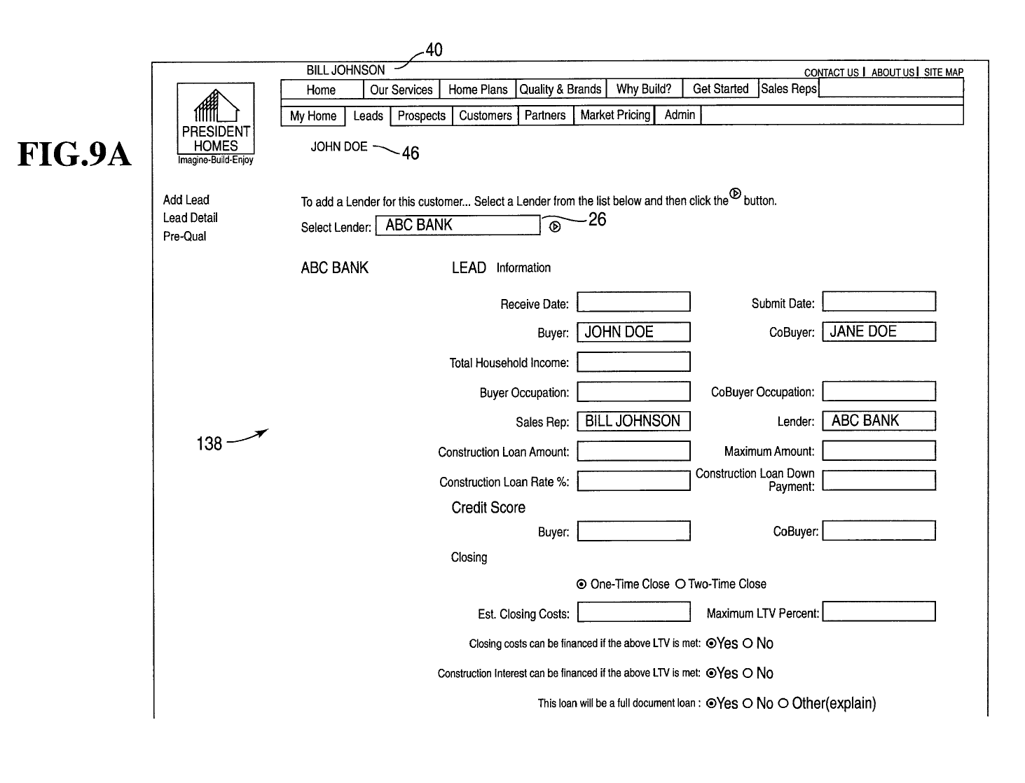

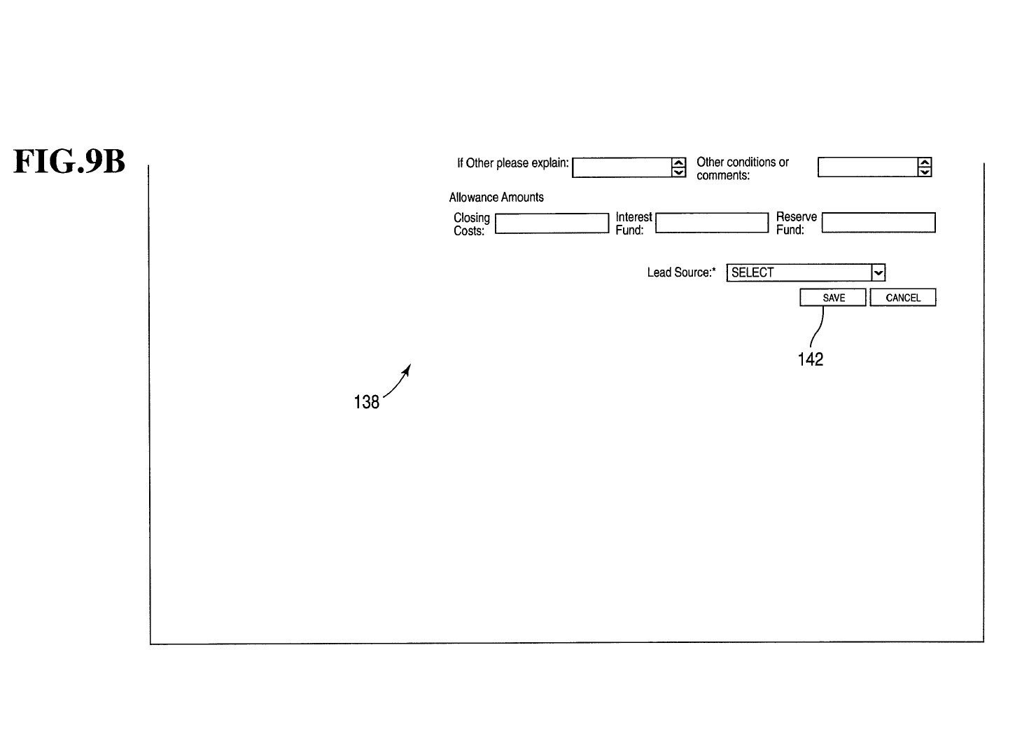

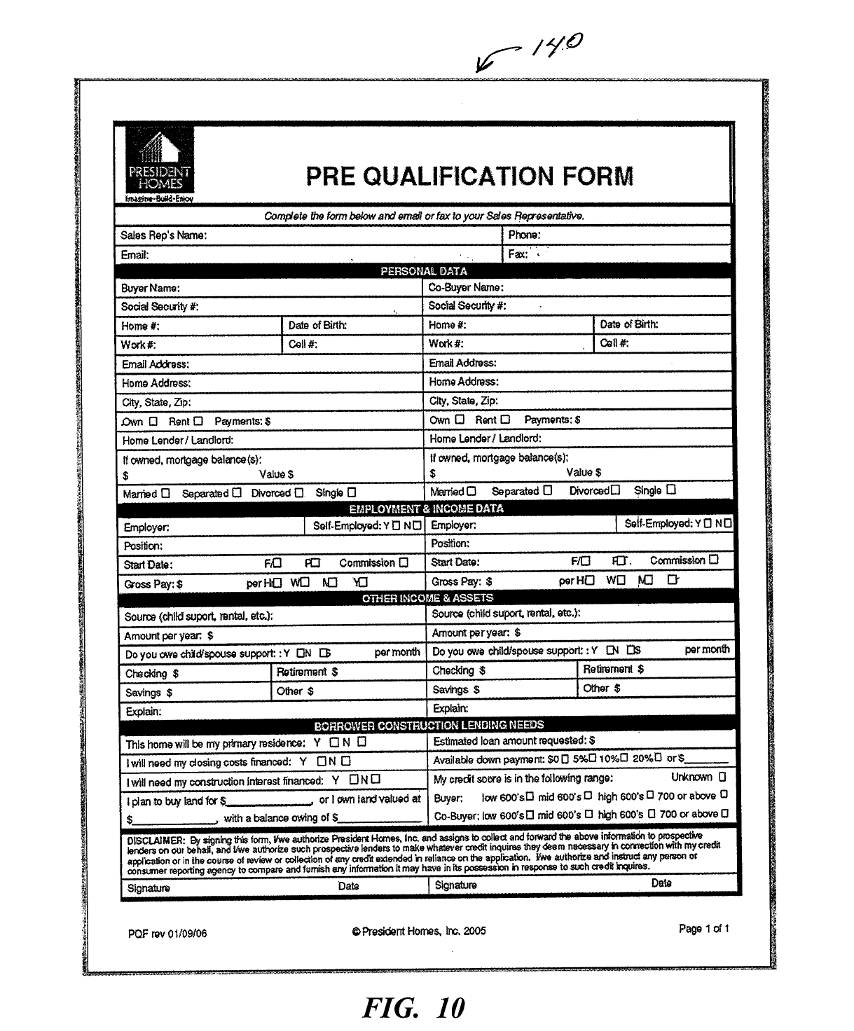

An example of a Pre-Qual Template 138 is illustrated in FIGS. 9A-9B. The Sales Rep 40 preferably fills in the various fields on the form specifying the dollar amount and interest rate of the construction loan for which the Lead 46 has been pre-qualified by a Lender 26. It should be understood that the Lender 26 bases the amount of the construction loan and interest rate for which the Lead qualifies based on the financial information provided by the Lead 46 through a Pre-Qualification Form 140 (FIG. 10). The Pre-Qualification form 140 is preferably a fillable form accessible through the publicly accessible side of the web-base Program 14. The Lead 46 preferably completes the form 126 which can then either be emailed or printed and then mailed to the Sales Rep 40. The Sales Rep 40 preferably Provides the completed form to at least two Lender 26 from the ASP's pool of qualified Lenders. Alternatively, the form 126 can be completed and submitted by the Lead to a Lender of the Lead's own choosing.

In the preferred method, the ASP will have previously established a pool of Lenders 26 who are licensed in the state in which the Lead resides, who have experience in owner-involved construction financing, and who can provide competitive quotes. The pool of Lenders 26 may comprise national or local mortgage brokers. It is preferable that the Lenders 26 also have the appropriate network of appraisers, title searchers, and other individuals necessary to close the construction financing for the Lead 46 if and when the need arises.

As previously identified, the Sales Rep 40 receives the Lender's prequalification quote the Sales Rep 40 and preferably inputs the Lenders' quotes into the “Pre-Qual” Template 128. The Sales Rep then preferably contacts the Lead 46 to discuss and advise the Lead 46 (if necessary) on which Lender quote to choose. At the direction of the Lead 46, the Sales Rep 40 selects or inputs the Lender and verifies the pre-qualified loan amount and interest rate prior to clicking the “save” button 142 (FIG. 9B). Upon clicking the “save” button 142, the Lead 46 now becomes a “Prospect” 48. Upon the Lead becoming a Prospect, the Sales Rep homepage 116 (FIG. 5) is updated by populating the Active Prospects field 143 (FIG. 7A) with the name of the new Prospect 48. The Sales Rep 40 now preferably begins to work with the Prospect 48 through the tasks and activities under the Imagine Stage 102 and Design Stage 104 (FIG. 2).

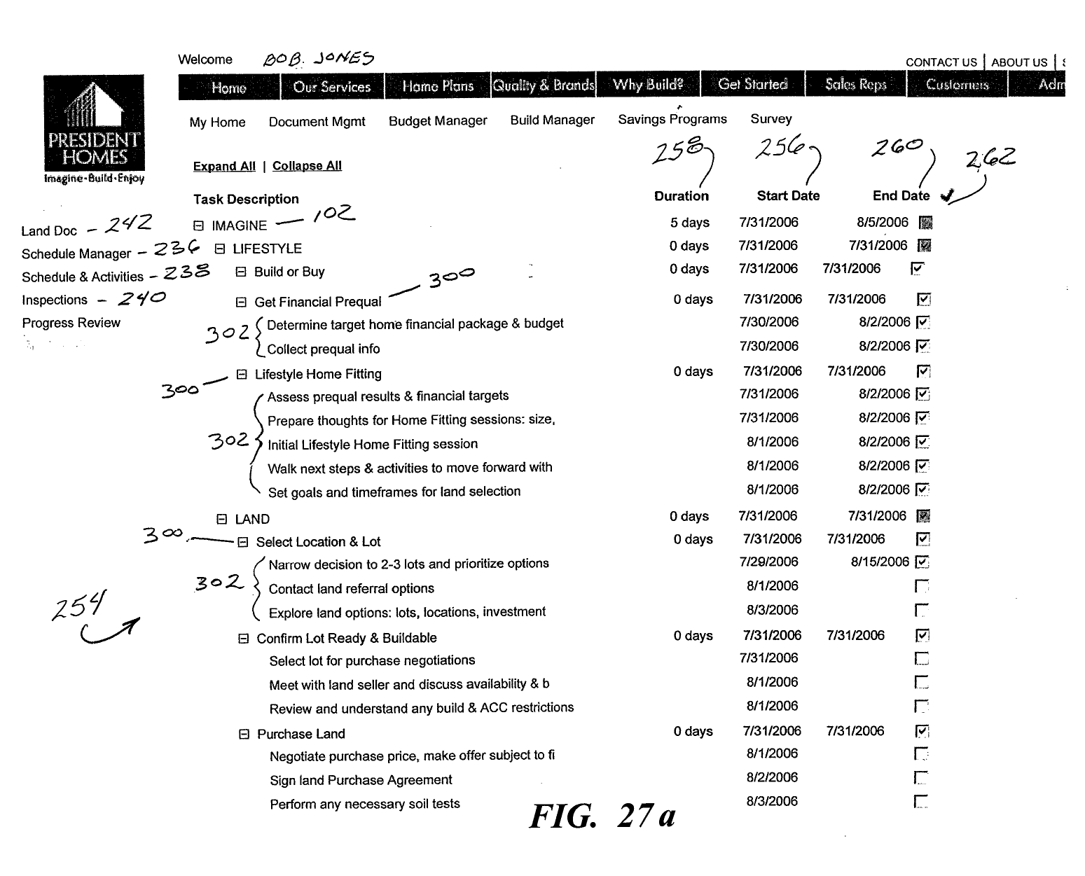

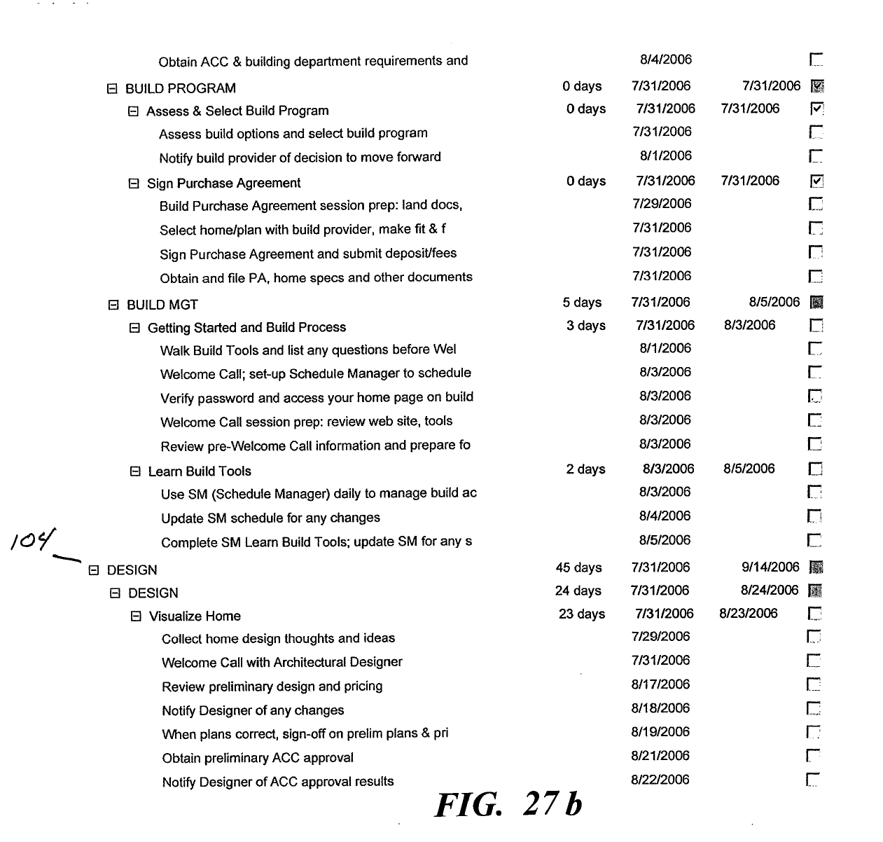

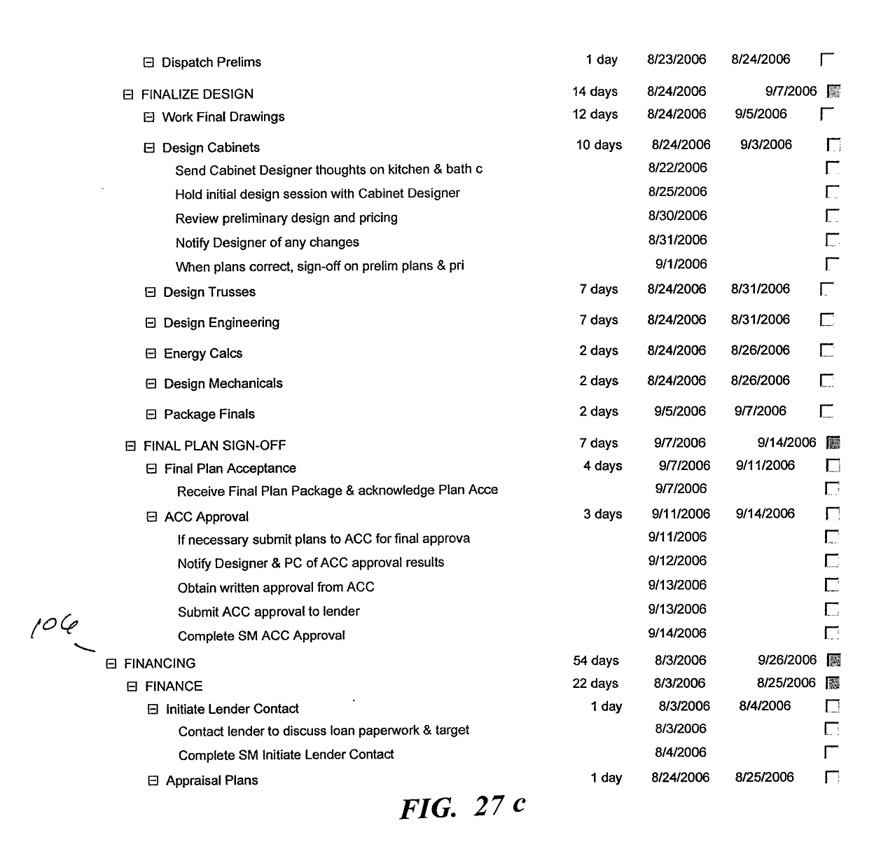

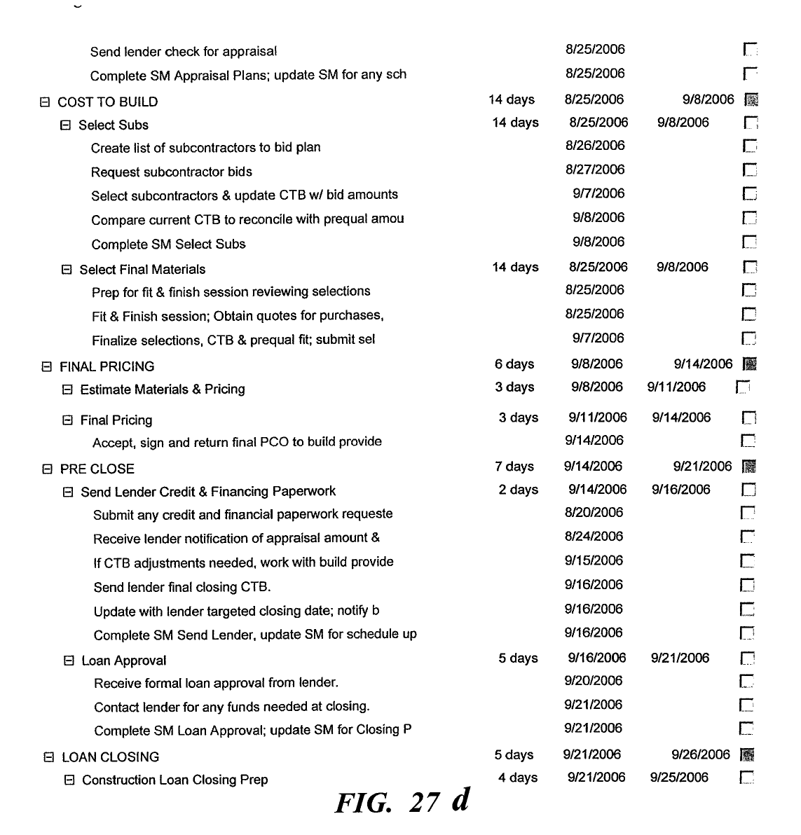

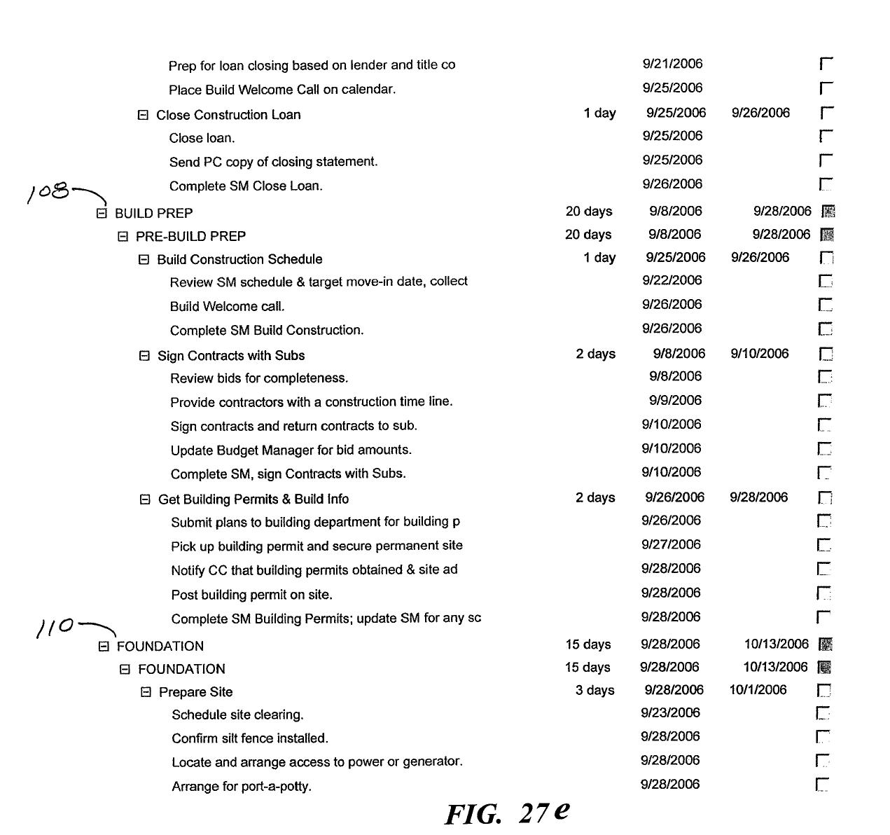

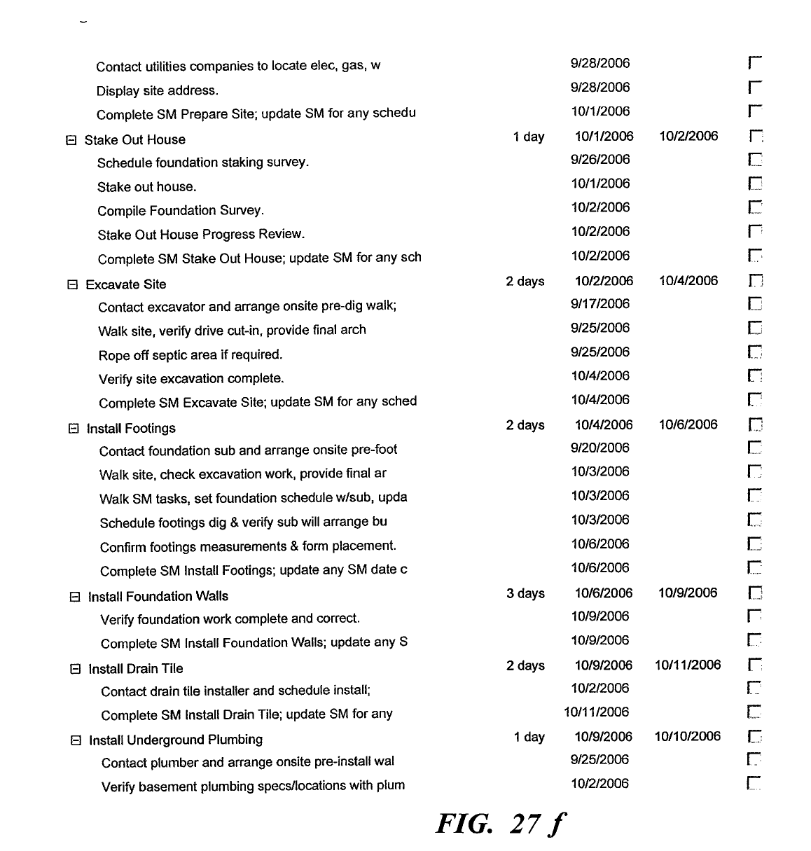

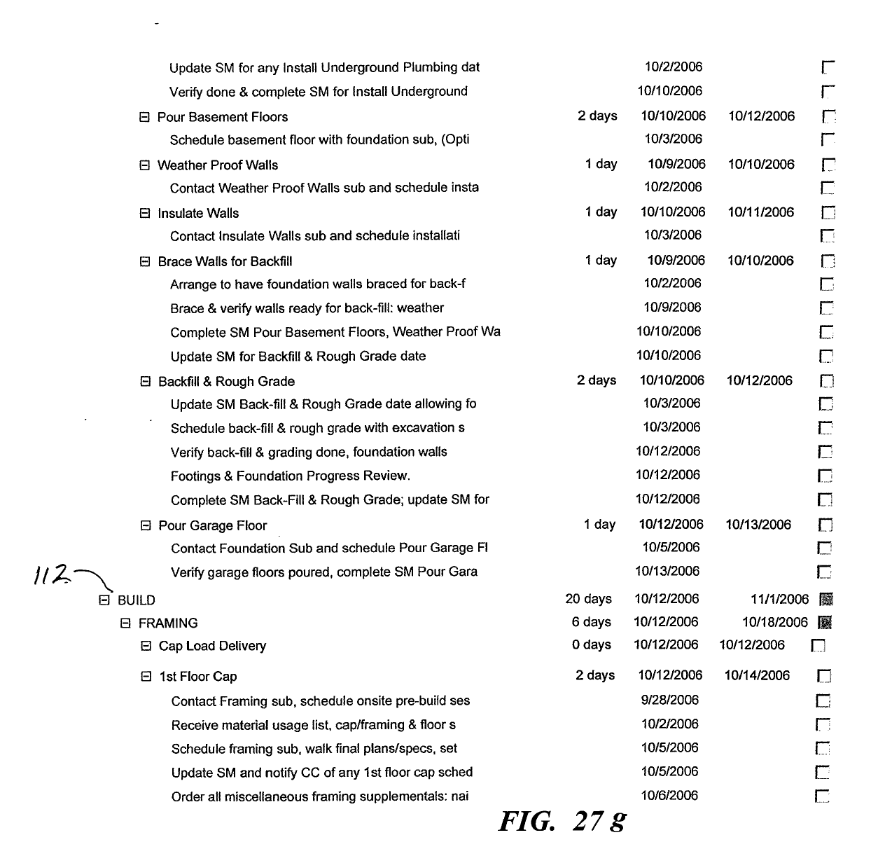

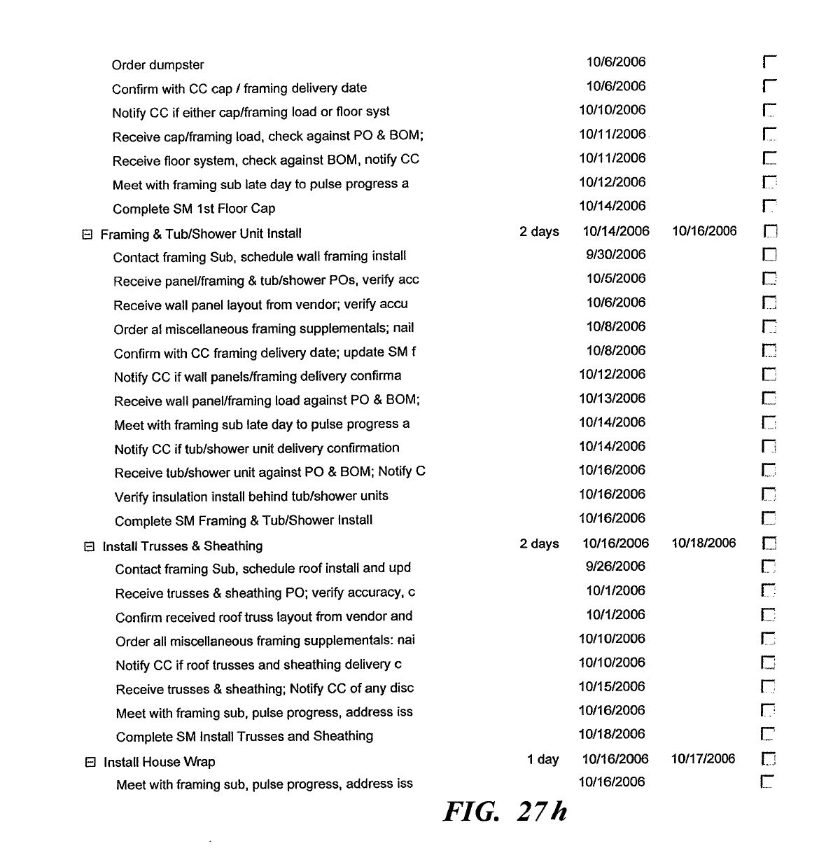

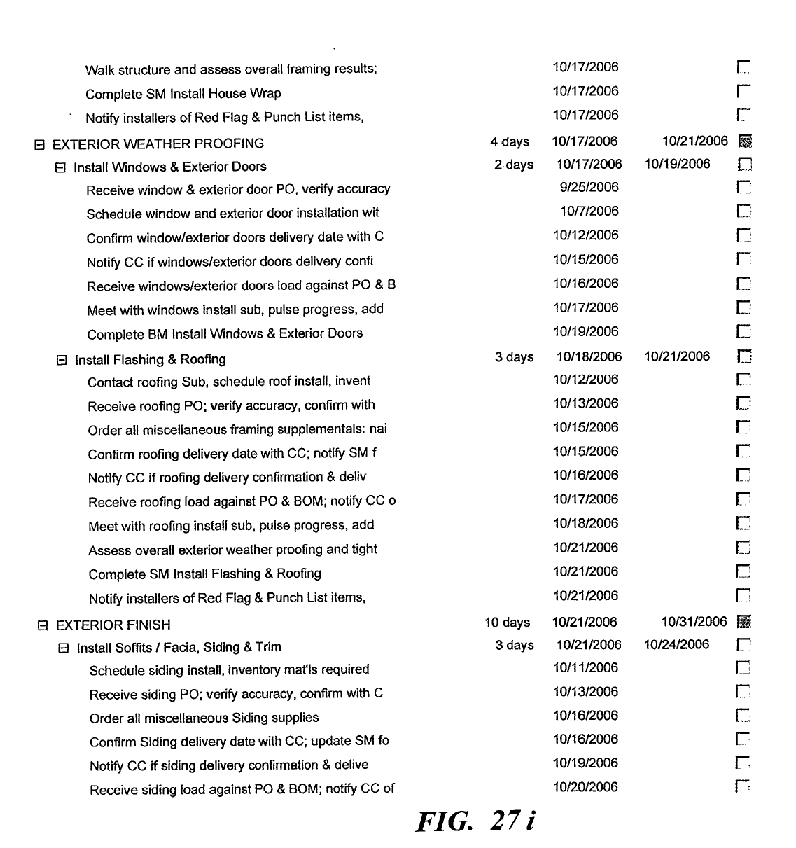

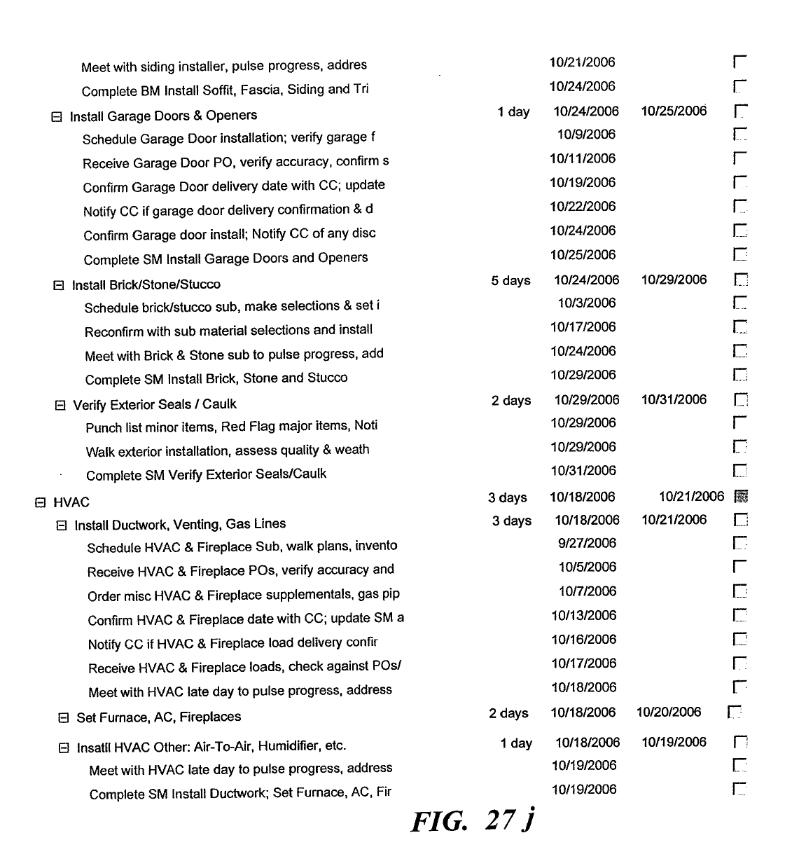

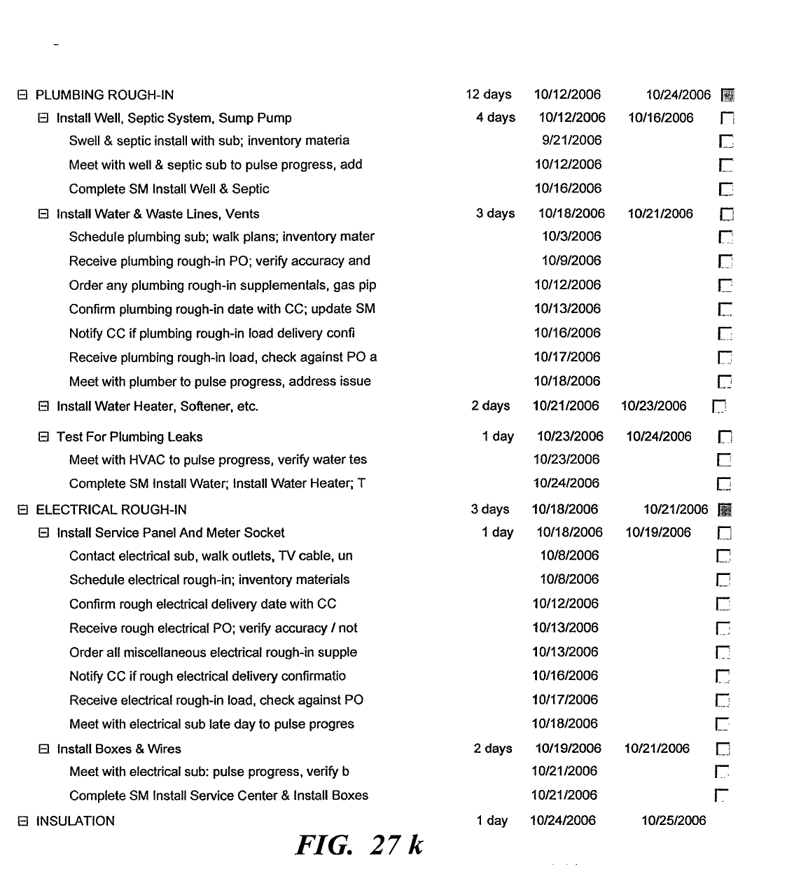

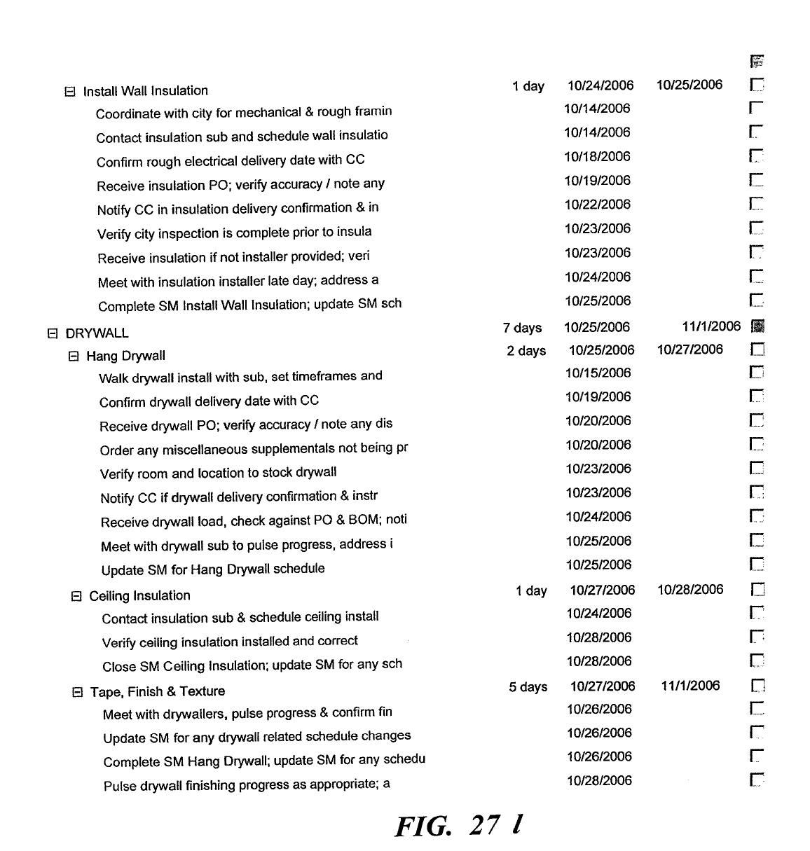

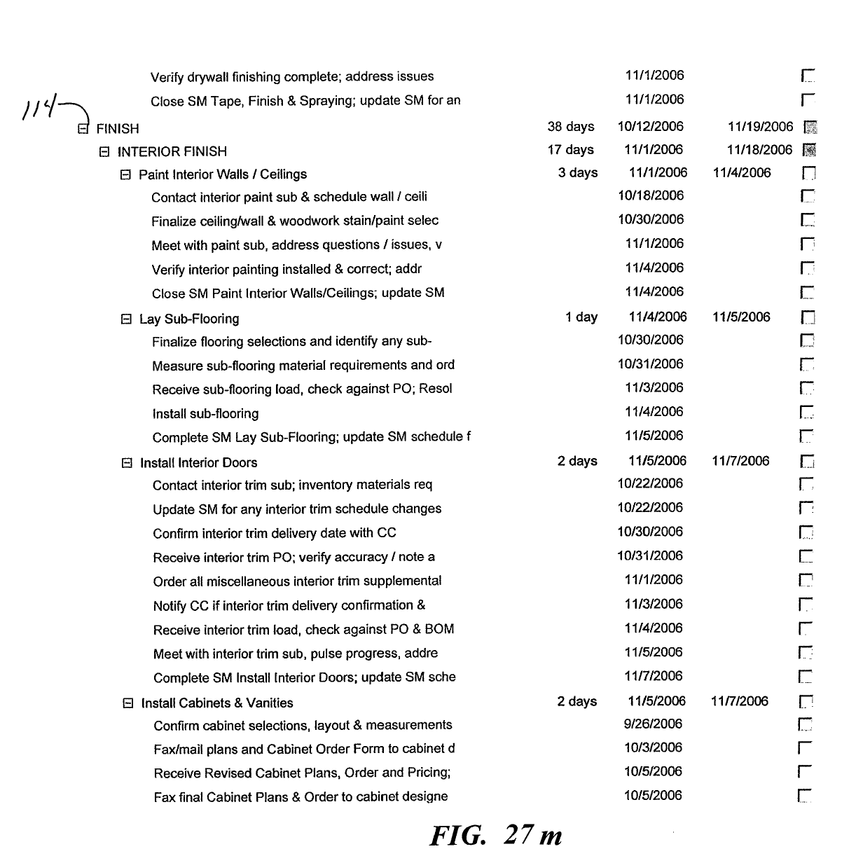

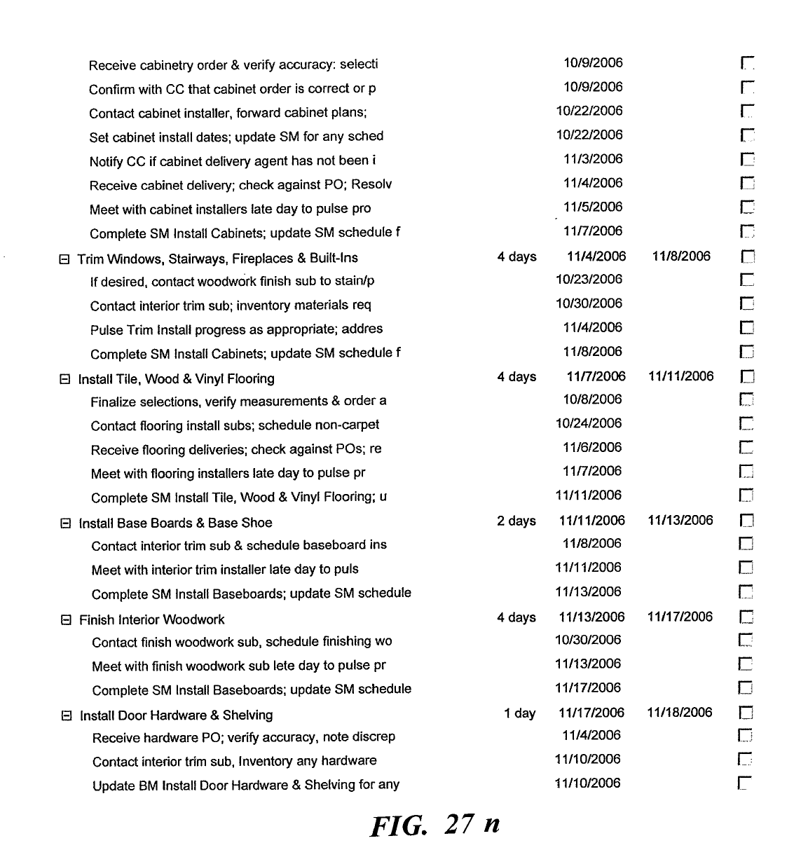

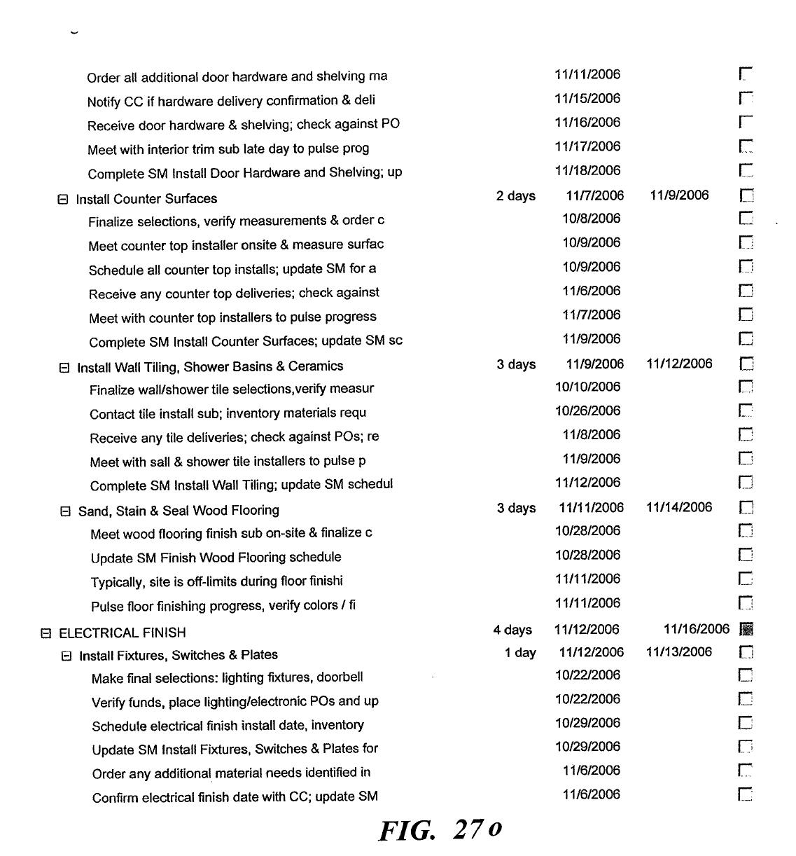

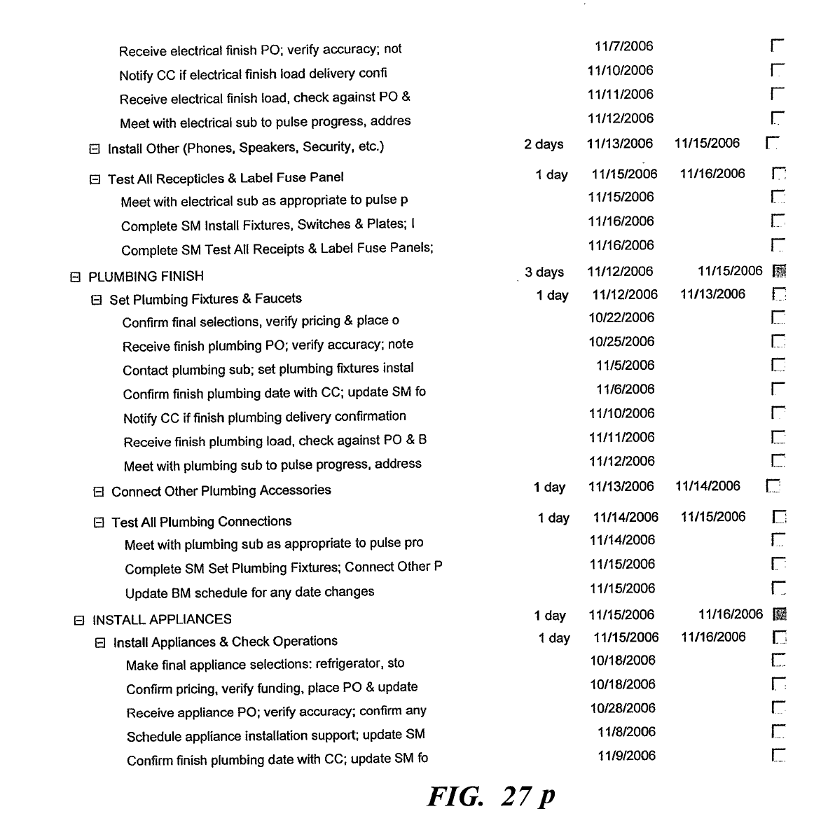

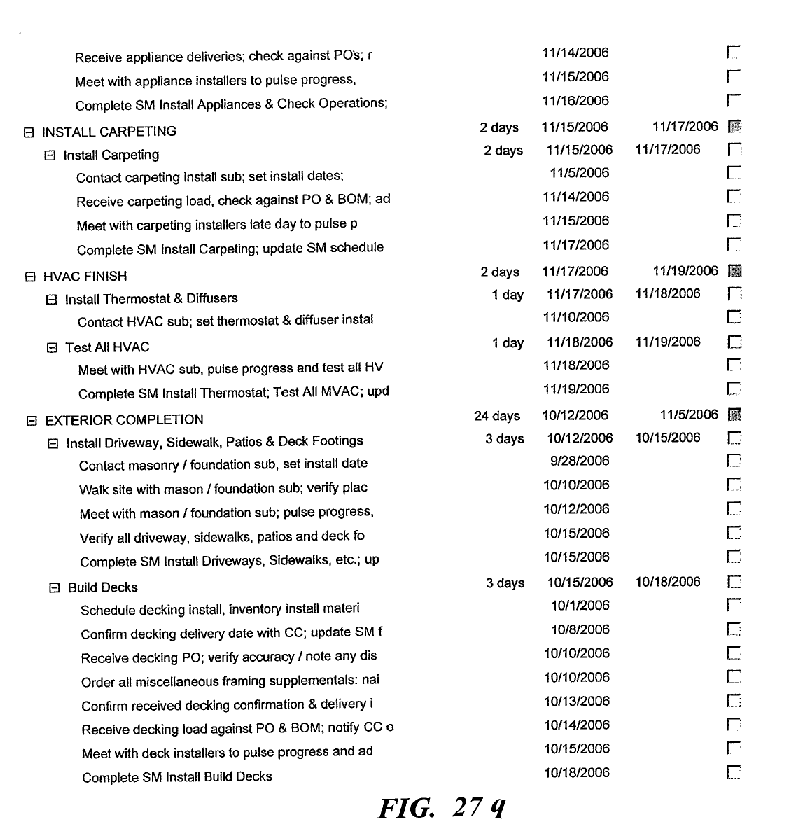

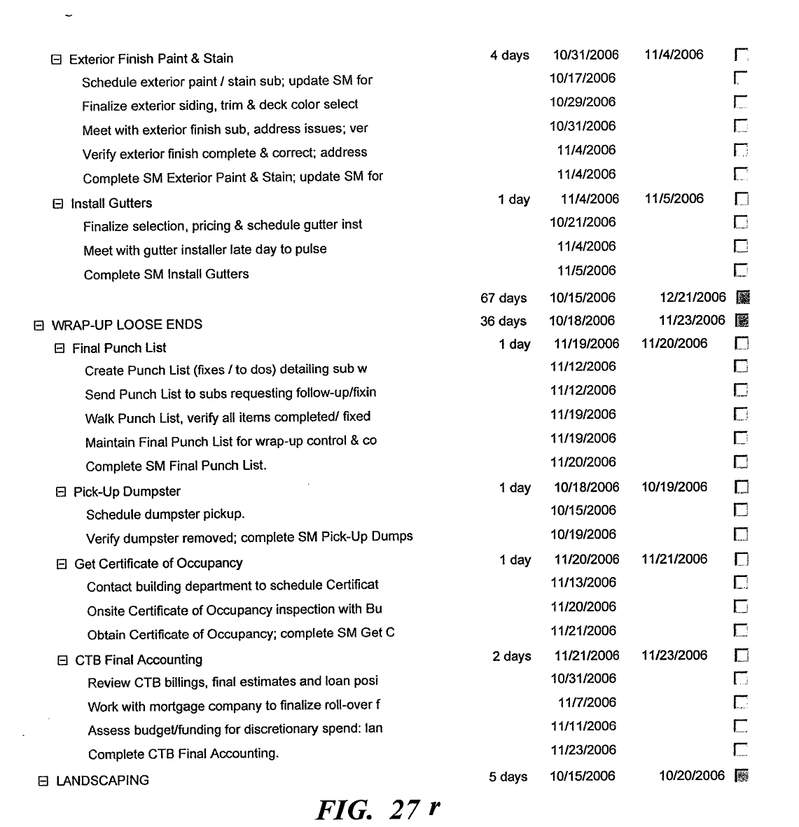

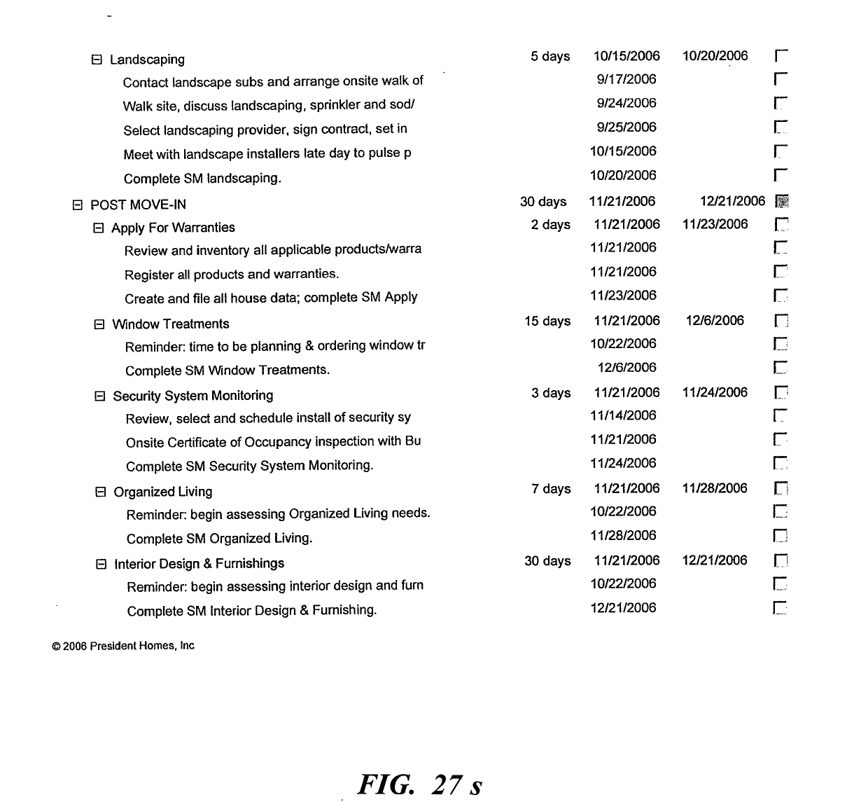

As will be discussed in detail later, referring to FIG. 27A-27S, each of the various stages 102-114 (FIG. 2) are broken down into or comprise various predefined Tasks 300 and Activities 302 that are to be completed. For example, as identified in FIG. 27A, during the Imagine Stage 102, one of the Tasks 300 is to complete a “Lifestyle Home Fitting”. Under this Task 300 are a number of listed Activities 302 that will enable the timely completion of that task. These Activities 302 include reviewing and consulting with the Prospect about the Pre-Qual results and financial targets and discussing home fitting issues with the Prospect, i.e., size, cost, budget, etc., and lifestyle issues. Another Activity requires that the Sales Rep discuss with the Prospect the various steps and activities required to construct the home, and the Prospects goals and timeframes for land selection. The Sales Rep also preferably advises and consults with the Prospect 48 concerning the Tasks and Activities in connection with the land and the type of “Build Program” 50 to be selected by the Prospect 48.

As used herein the term “Build Program” 50 refers to the level of services the Prospect/Customer wishes the ASP to provide. The level of services may be certain “packaged” services established by the ASP. These packaged services may vary from extensive involvement and close step-by-step hand-holding of the Prospect/Customer through the entire construction process. Another “package” Build Program 50 may include only limited services wherein the Prospect/Customer is essentially on his/her own and relies on the ASP only nominally for guidance or assistance. Another “packaged” Build Program 50 may include an intermediate level of ASP services between these two extremes. Additionally, or alternatively, the Build Program 50 may include different amounts or levels of “sweat equity” the Prospect/Customer intends to provide. Furthermore, the Build Program 50 may include stock or custom architectural plans, bill of material listings, etc. It should be appreciated that the cost of the differing Build Program packages will vary depending on the services provided by the ASP and the amount of sweat equity the Prospect/Customer provides. The options selected by the Prospect/Customer define the “Build Package.”

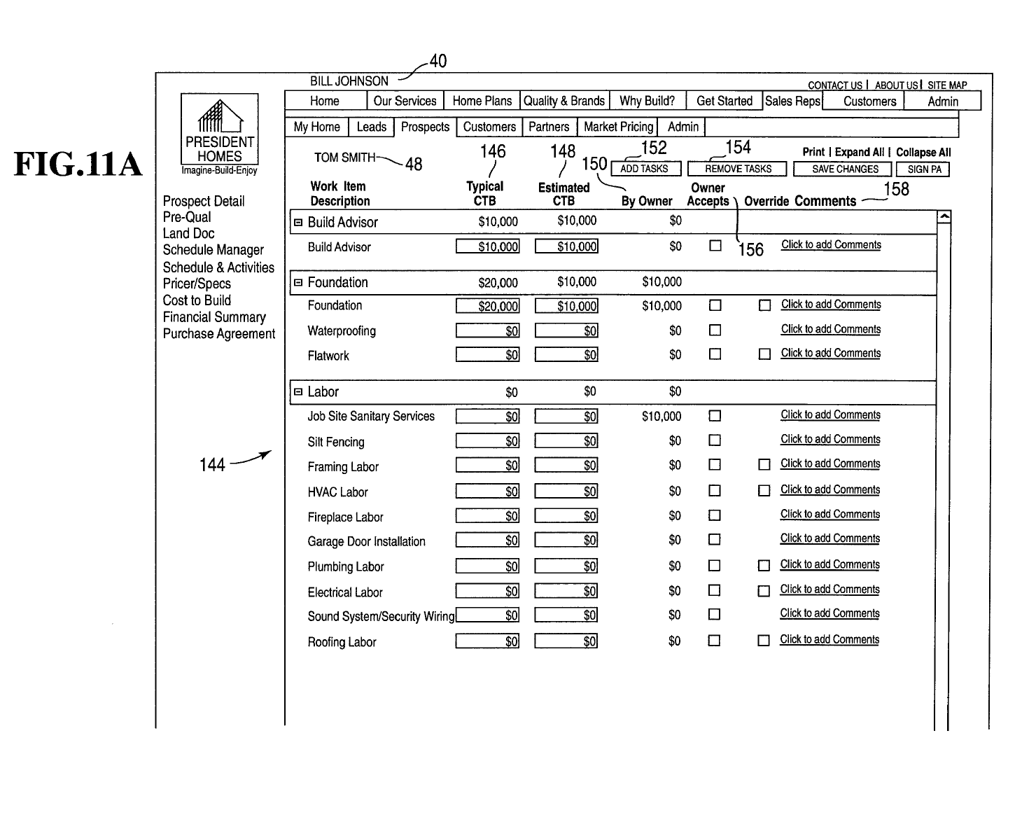

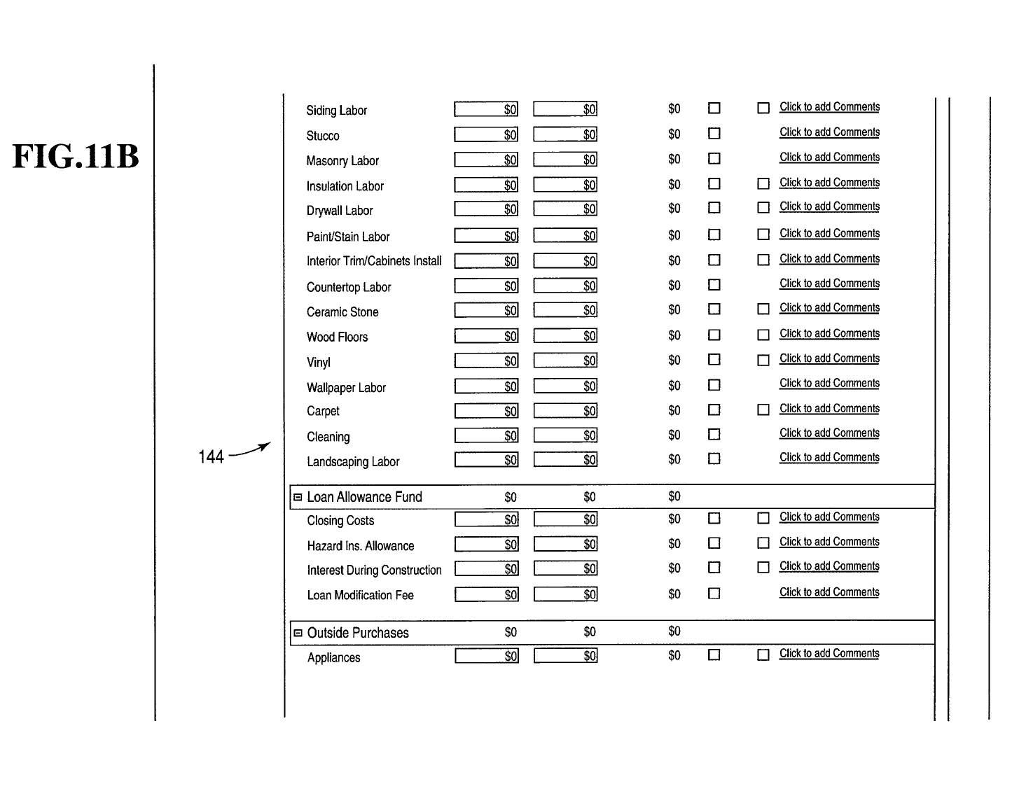

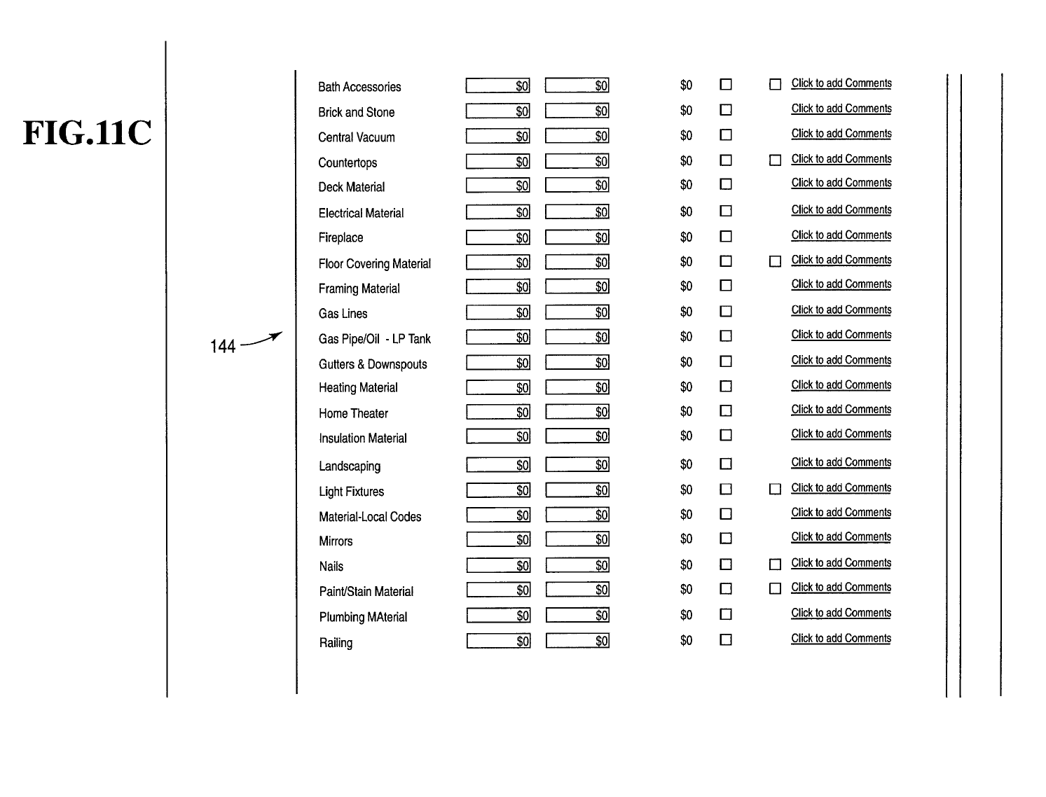

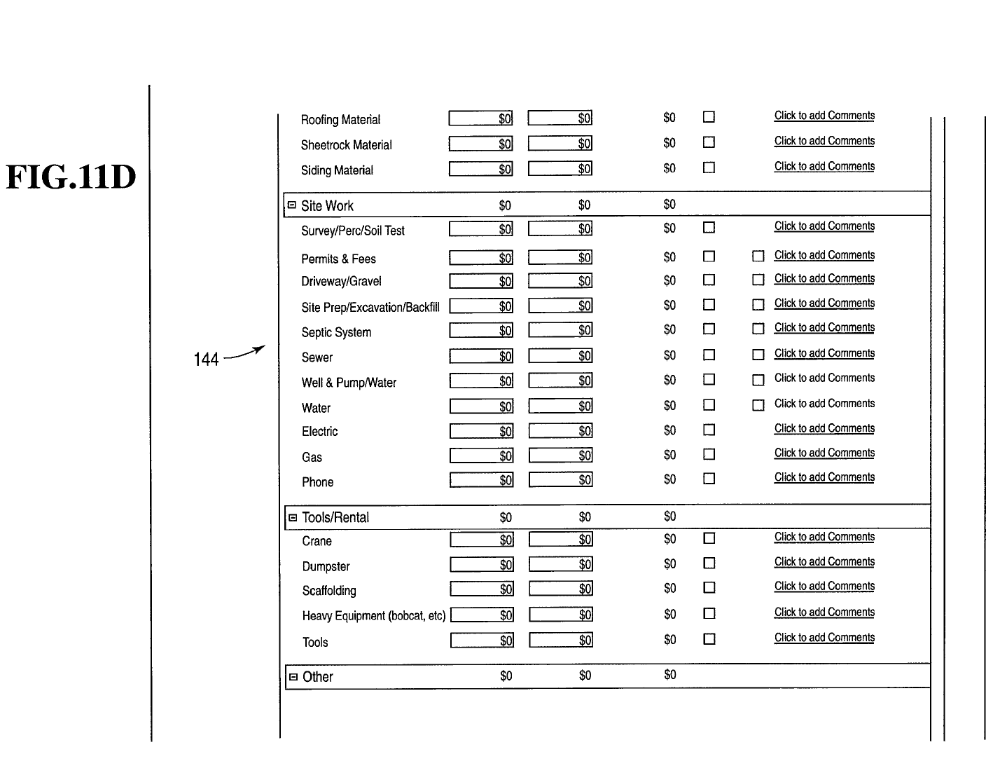

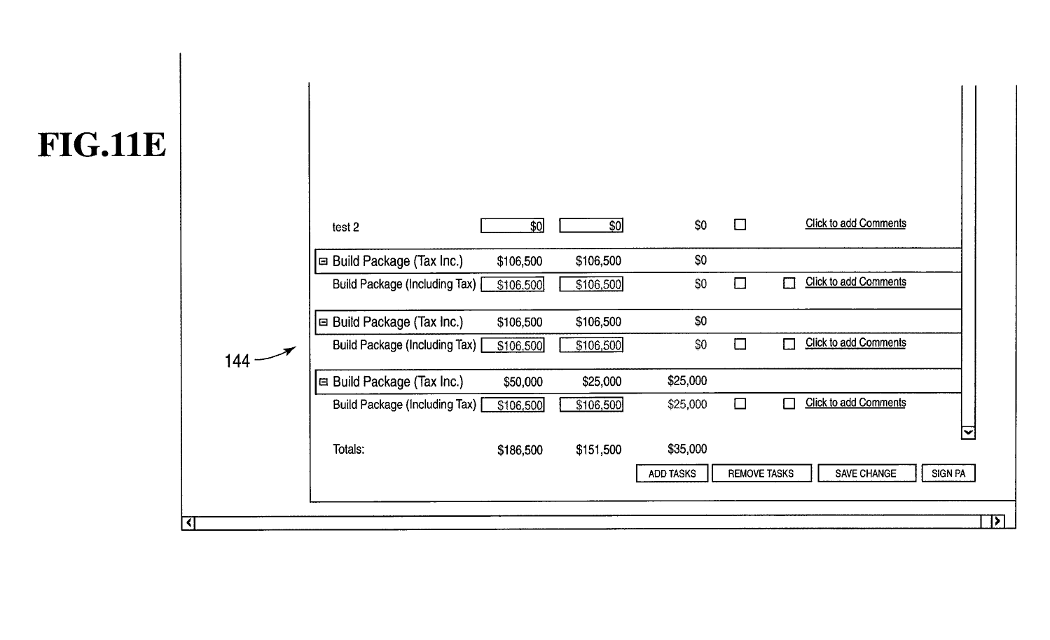

The Build Package is often dictated by the Prospect's Pre-Qual 130. Thus, during the Imagine Stage 102 and Design Stage 104, it is preferable to provide the Prospect with the information necessary to make an informed decision on the type of home, the location of the home, home amenities, etc. that the Prospect can afford before entering or proceeding too far down the Design Stage 104. Accordingly, another preferred feature of the system and method of the present invention is to provide Cost-To-Build (CTB) Template 144. An example of a CTB Template 144 is illustrated in FIGS. 11A-11E. The CTB Template 144 includes a Typical Cost-To-Build (CTB) field 146. The Typical CTB field 146 is preferably populated with an average cost for each of the particular work items listed. The average cost for the particular work item is preferably based on data obtained from the National Association of Home Builders, RS Means or other reputable source of home CTB data for a particular geographic area, home size, home style, etc. In the example of FIG. 11, with respect the foundation, the typical CTB is $20,000. Also included in the CTB Template 144 is an Estimated CTB field 148. The Estimated CTB field 148 allows the Prospect/owner to input the dollar amount that he/she believes it will actually cost for that particular work item. In the example of FIG. 11, the Prospect (Tom Smith) believes that his Estimated CTB for the foundation will only be $10,000. A lower or higher Estimated CTB may be due to any number of reasons or factors. For example, Tom Smith may himself be a foundation contractor. Therefore his labor and equipment costs may be significantly less than having to subcontract that work out to a third party Subcontractor. If the Estimated CTB is less than the Typical CTB for a particular item, the “By Owner” field 150 for the corresponding work item is automatically calculated and displayed as the difference between the Estimated CTB and the Typical CTB for that work item.

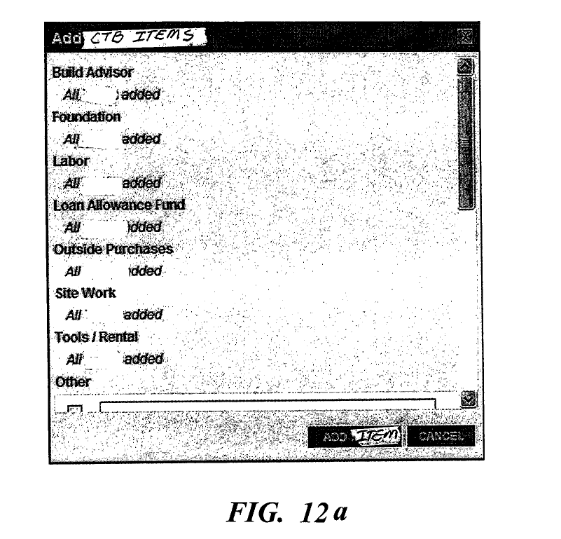

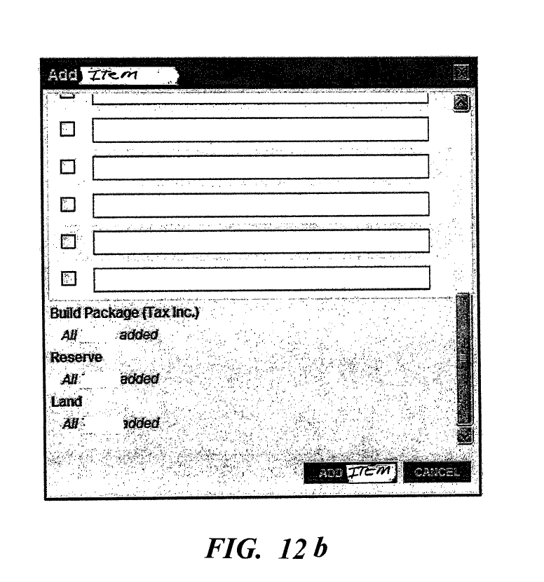

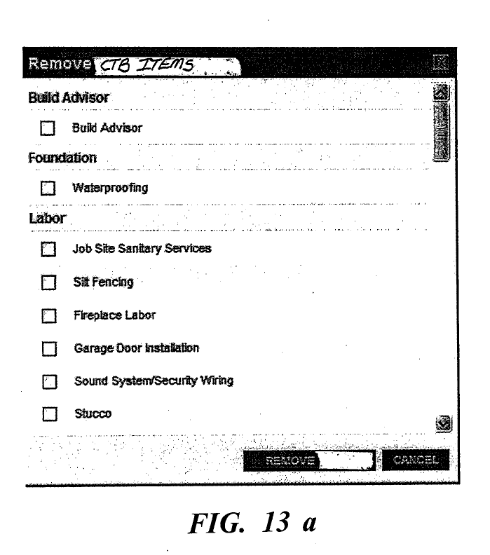

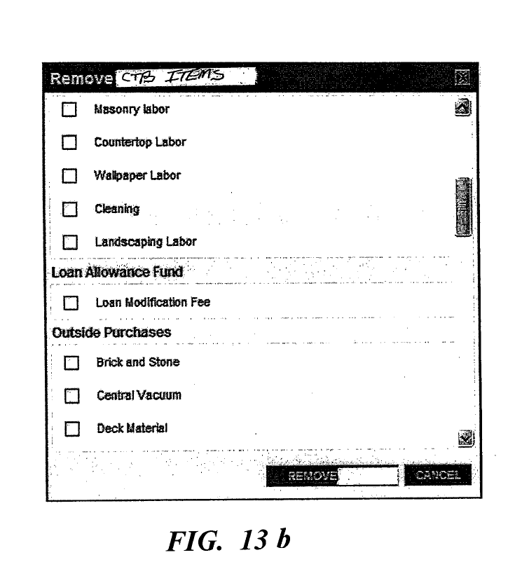

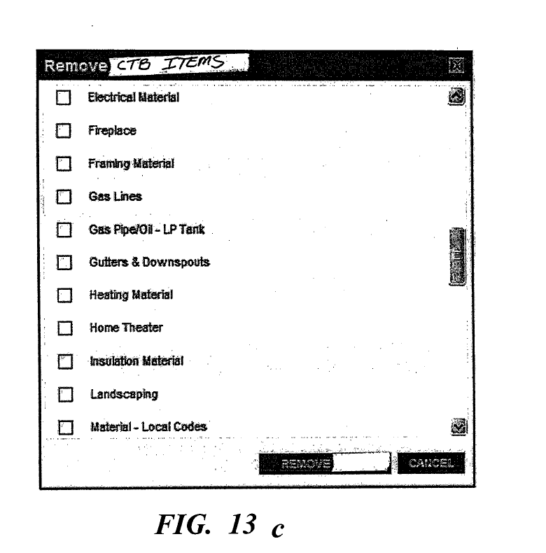

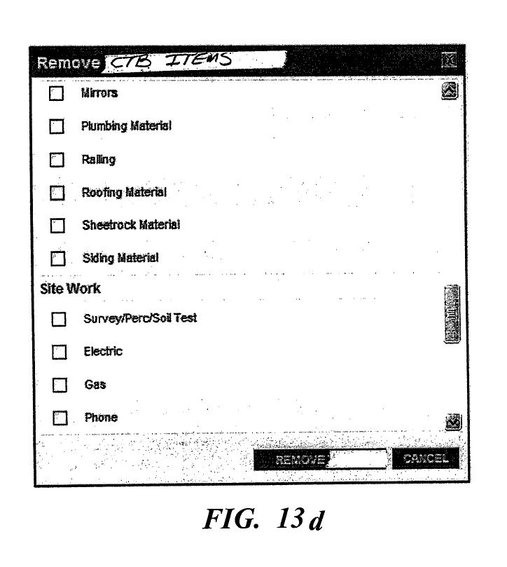

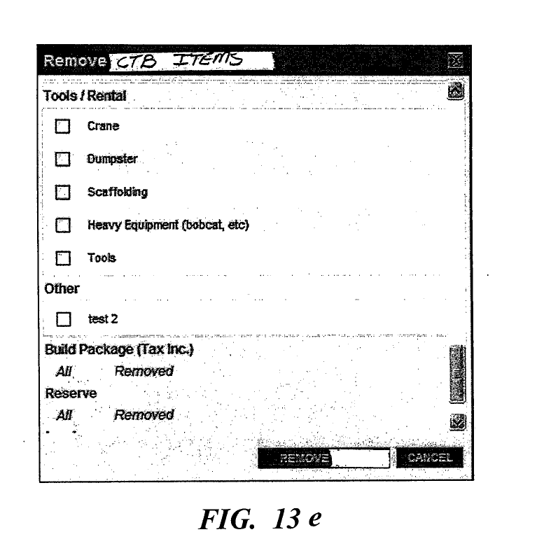

In the preferred embodiment of the CTB Template 144, there are tabs 152, 154 which permit the Sales Rep to add or remove work items from the list. FIGS. 12A-12B and FIGS. 13A-13F illustrate examples of a window that may open to permit the Sales Rep 40 to select the work items to be added to or removed from the listing, respectively.

Referring back to FIG. 11, in the preferred CTB Template 144, there is included an “Owner Accepts” field 156 and an “Override” field 158. Preferably, the Owner Accepts field 156 requires a check in the check box if there is a value in the corresponding “By Owner” field 150. The requirement of a check in the corresponding checkbox is simply a way to ensure that the Sales Rep and Prospect/Owner discuss the issue and that the Prospect/Owner acknowledges his acceptance of the responsibility for making up any difference between the typical CTB and estimated CTB. It should be noted that in the preferred CTB Template 144 an override box 158 does not available for every work item. Preferably, the work items with an override box 158 cannot be removed from the CTB Template list by using the Remove items window. This is because every home generally requires a foundation, flatwork, framing labor, HVAC labor, plumbing labor, etc. However, by checking the override box it permits the Sales Rep to have a zero value in the Estimated CTB field 148 for a particular work item that cannot otherwise be removed. In order to have a zero value in the Typical CTB field 146, the corresponding override box for that item must be checked. Thus it should be appreciated that the purpose of the checkboxes are for ensuring that every item was considered and not overlooked by require either a dollar amount, an acknowledge of owner acceptance, or an override.

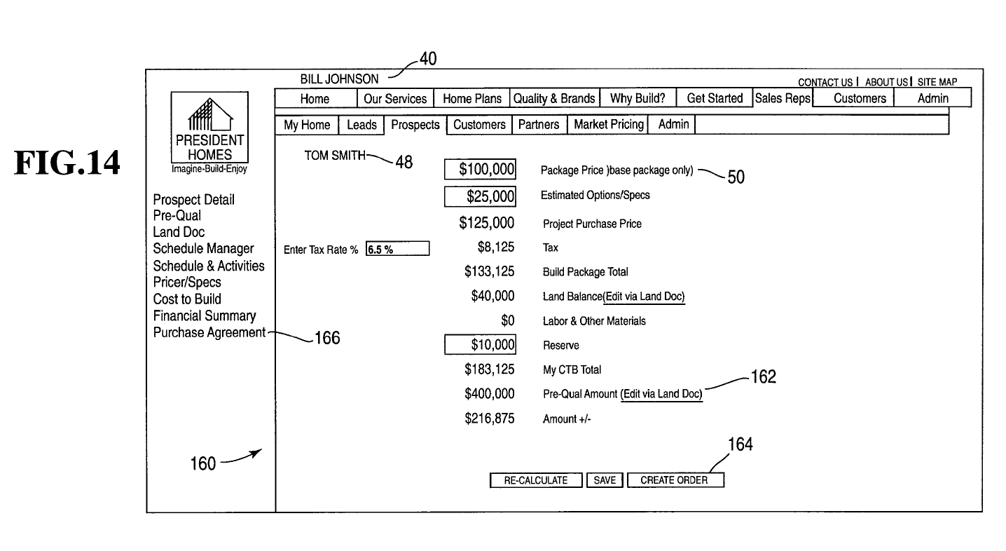

FIG. 14 illustrates a Financial Summary Template 160 populated with the dollar amounts from the CTB Template 144 for the Build Package and applicable taxes. The Financial Summary Template 160 also preferably displays the “Pre-Qual Amount” 162 or the amount of financing for which the Prospect has been prequalified. Upon clicking the Create Order button 164, the Program 14 preferably validates the data in the CTB Template 144 to ensure that all of the fields are filled in with either a dollar amount and/or include a check mark in the Owner Accepts field 156 or Override field 158. If the data in the CTB Template 144 is validated the data in the various fields 146, 148, 150, 152, 154, 156, 158 is frozen so that the values cannot be edited. The Sales Rep can then select the Purchase Agreement tab 166 to generate a Purchase Agreement. Upon the Prospect executing the Purchase Agreement the Prospect becomes a “Customer” 60.

Upon becoming a Customer 60, the individual is assigned a username and password for remotely accessing certain features and functionalities of the Program 14 through the ASP's website. Some of these features/functionalities include the Budget Manager, the Build Manager, and the Document Manager. Each of which is discussed separately below.

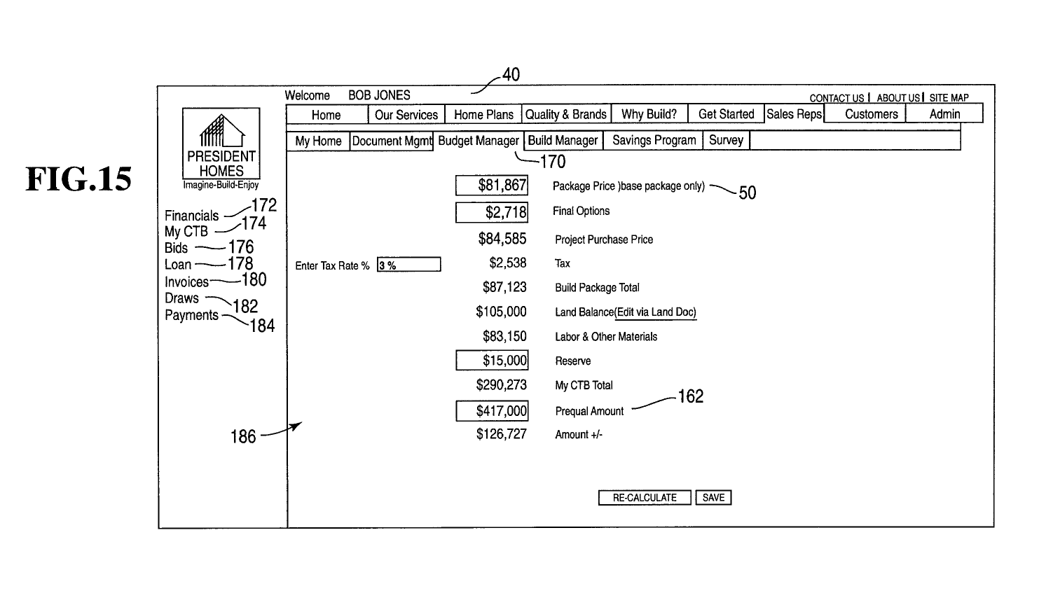

Examples of the preferred features and functionalities of the Budget Manager are illustrated in FIGS. 15-25. Preferably both the Customer 60 and the Sales Rep 40 have access to the Budget Manager. The Budget Manager is preferably accessible by the Sales Rep through the “Customers” tab 170 on the Sales Rep Homepage 126 (FIG. 7A). For the Customer, the Budget Manager is preferably accessible after the Customer logs in to the website by selecting the “Budget Manager” tab 172 on the Customer's homepage. Under the Budget Manager Tab 172, a number of left side navigation tabs 174-184 are preferably provided as illustrated in FIG. 15.

FIG. 15 illustrates a preferred embodiment of the Financial Summary Page 186 that is displayed upon selecting the “Financials” tab 172. The format and type of data displayed in the Financial Summary Page 186 is preferably substantially the same as that displayed in the Prospect Financial Summary page 160. In the illustration of FIG. 15, the Customer 60 is identified as “Bob Jones.”

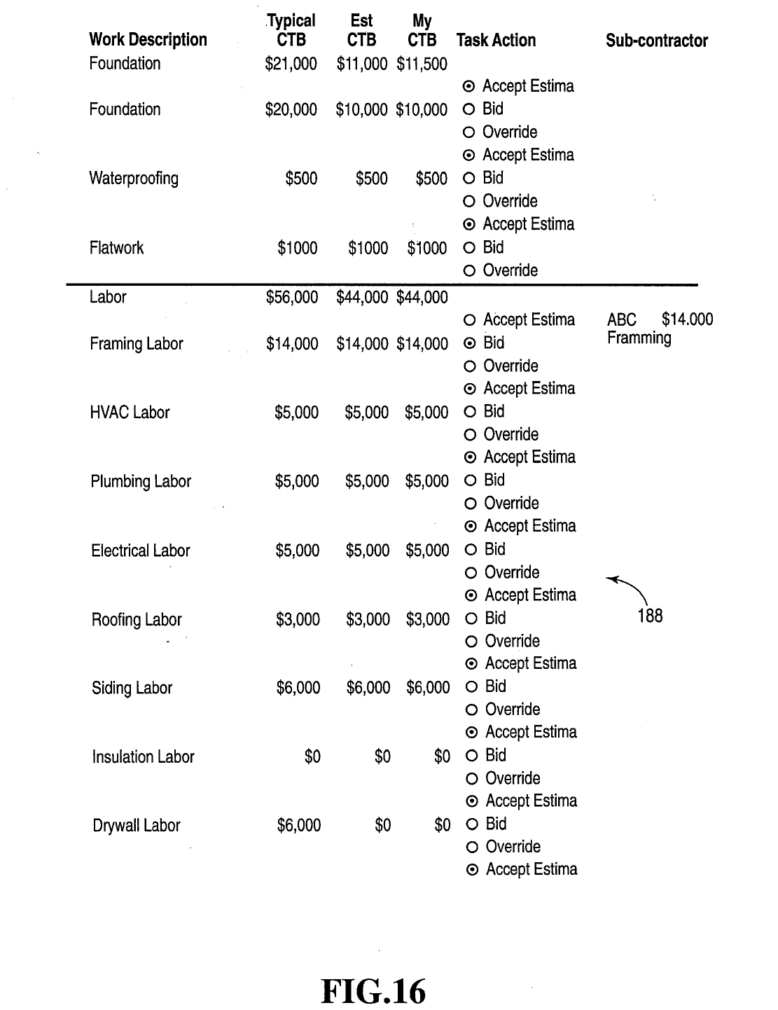

FIG. 16 illustrates a preferred embodiment of the My CTB Page 188 that is displayed upon selecting the My CTB tab 174. The My CTB page 188 displays whether the Customer has accepted the estimate for the work item or whether the Customer has obtained a bid for the work item.

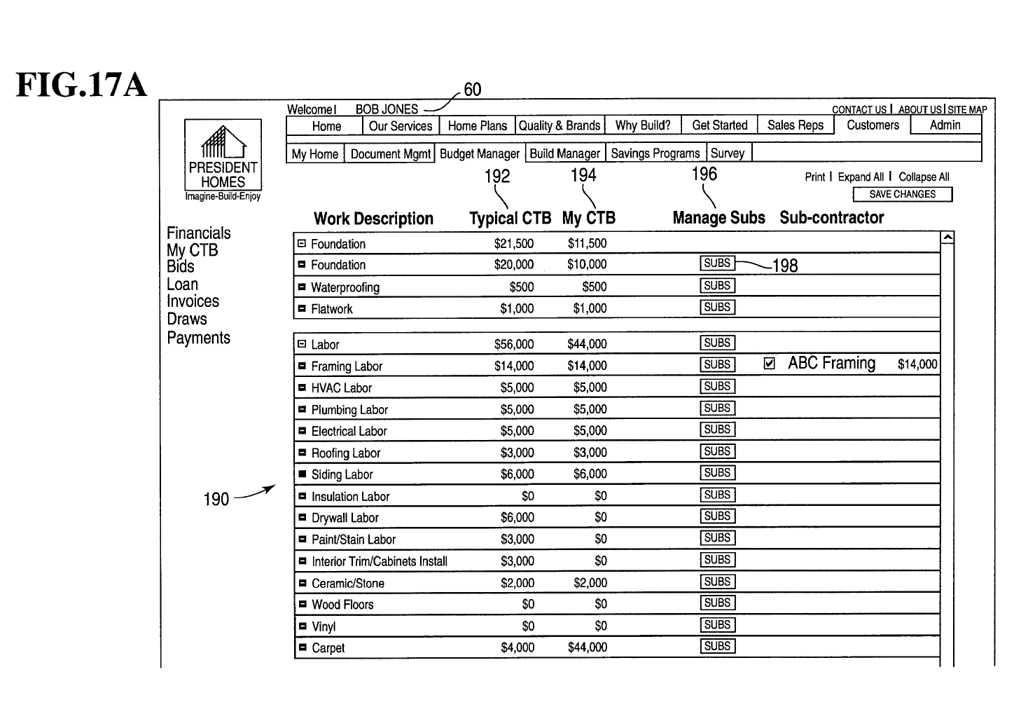

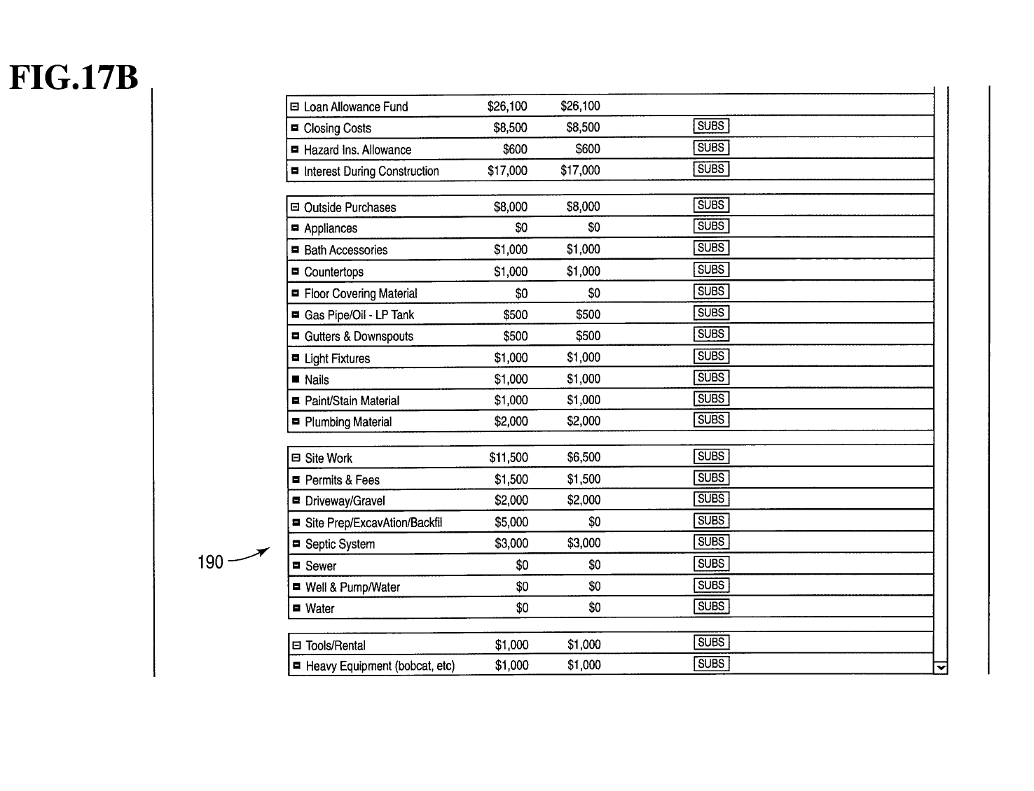

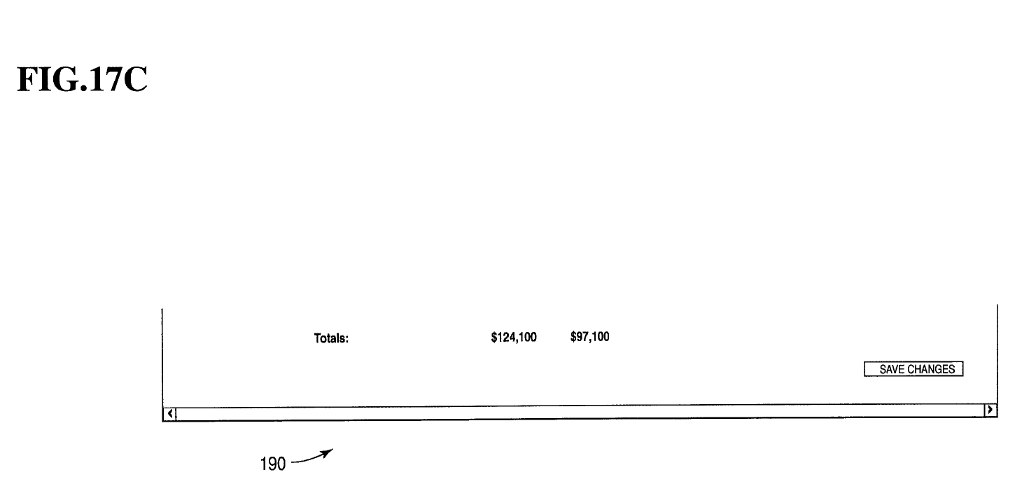

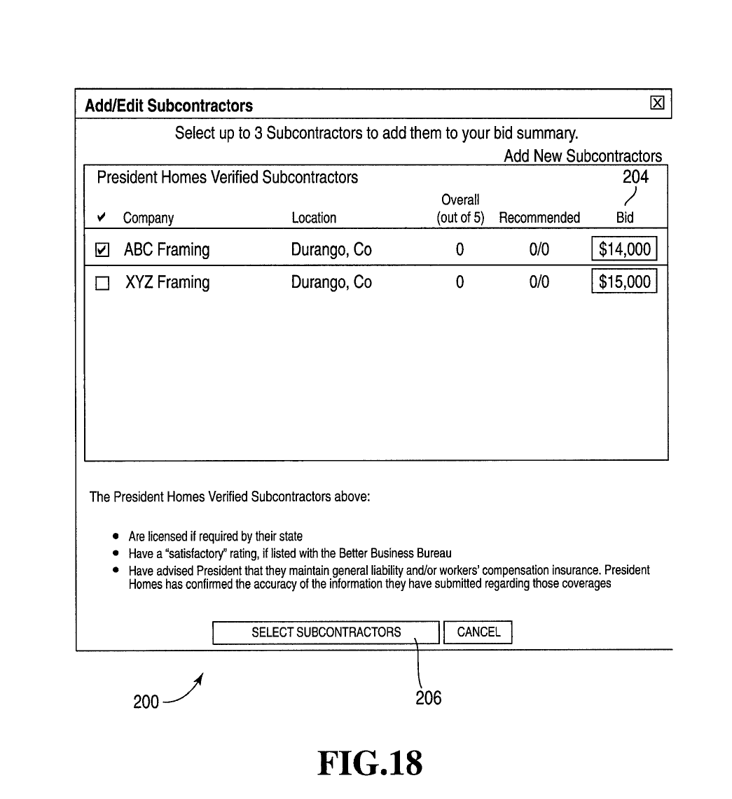

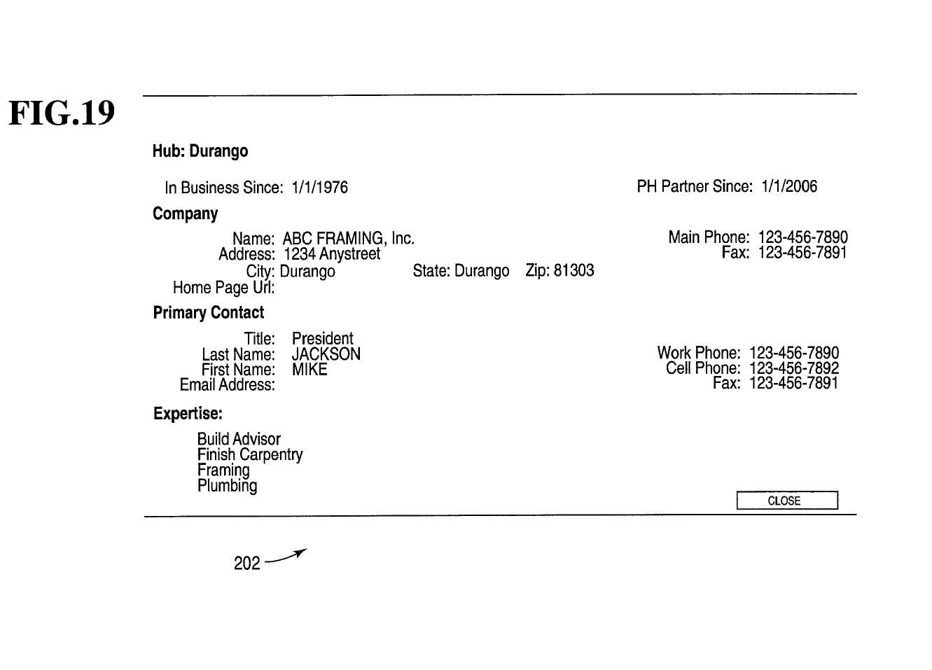

FIG. 17 illustrates a preferred embodiment of the Bid Page 190 that is displayed upon selecting the Bids tab 176. The Bid Page 190 includes a Typical CTB field 192 and a My CTB field 194. The data in the Typical CTB field 192 is frozen and corresponds to the data in the frozen Typical CTB data in the validated CTB Template 144 (FIG. 11A-11E). The My CTB field 192 is preferably editable, but is originally populated with the same estimated CTB data in the Estimated CTB Field 148 from the validated CTB Template 144 (FIGS. 11A-11E). Under the Manage Subs field 196, a Subs Button 198 is preferably provided that, when clicked, will open a Subcontractor Pool Template 200 (FIG. 18). The Subcontractor Pool Template 200 preferably displaying a pool of names of Subcontractors that the ASP has previously verified as a Subcontractor for the particular work item, and who is located in or near the geographic area where the Customer intends to build. Through this Subcontractor Pool Template 200, the Customer 60 can preferably click on the Subcontractor name which will open a Subcontractor Contact Template 202, an example of which is shown in FIG. 19, displaying detailed contact information for the Subcontractor.

The Subcontractor Pool Template 200 preferably includes a bid field 204 into which the Customer can enter the Subcontractors quote for the work. Additionally, the Subcontractor Pool Template 200 preferably includes a “Select Subcontractor” button 206 which, when clicked, will enter the quote from the checked Subcontractor into the My CTB field 194 of the My CTB Page 190. Thus, this feature enables the Customer to enter actual bids to obtain a more accurate CTB.

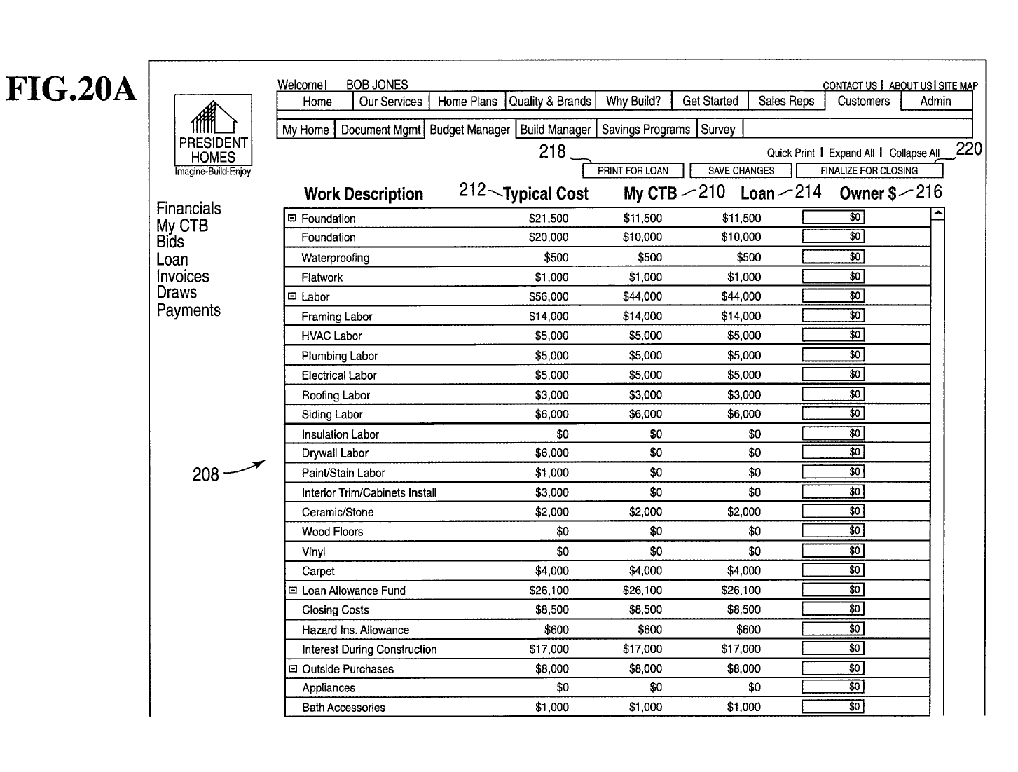

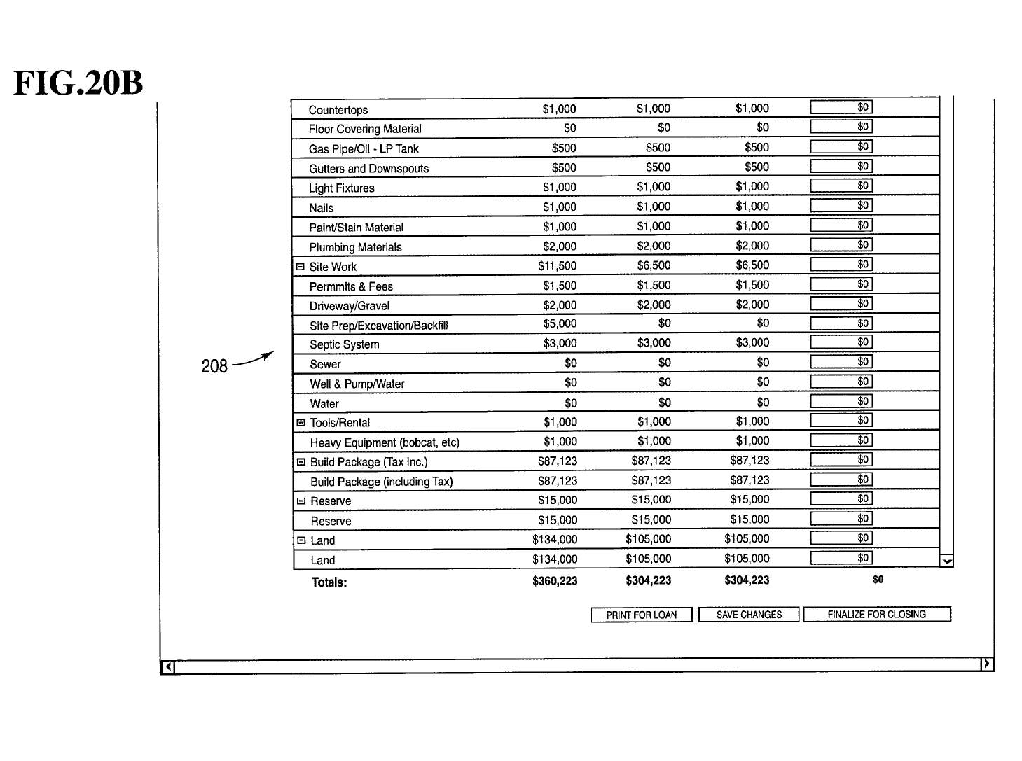

FIGS. 20A-20B illustrate a preferred embodiment of the Loan Page 208 that is displayed upon selecting the Loan tab 178 under the Budget Manager Tab 170. Through the Loan Page 208, the values under the My CTB field 210 are populated with the same values as under the My CTB field 194 under the Bids Page 190 (FIG. 17A-17C). The values for each work item under the Typical CTB field 212 remain frozen. The values under the Loan field 214 for each work item is the difference between the values for the Typical CTB 212 minus the values from the corresponding My CTB field 210 less any dollar amount entered under the Owner $ field 216. Once a dollar value for all applicable work items on the Loan Page 208 are entered, the Customer can select the “Print for Loan” button 218 to obtain a formatted document displaying the work items and the dollar values under each of the fields 210, 212, 214, 216 substantially in the format as displayed on the screen. The Customer 60 can then take this printed loan document to the Lender 26 previously selected during Pre-Qual. After final loan approval from the Lender 26, the Customer preferably selects the “Finalize For Closing” button 220 which causes the Program 14 to lock the values under the Loan Field 214 so the values cannot be changed.

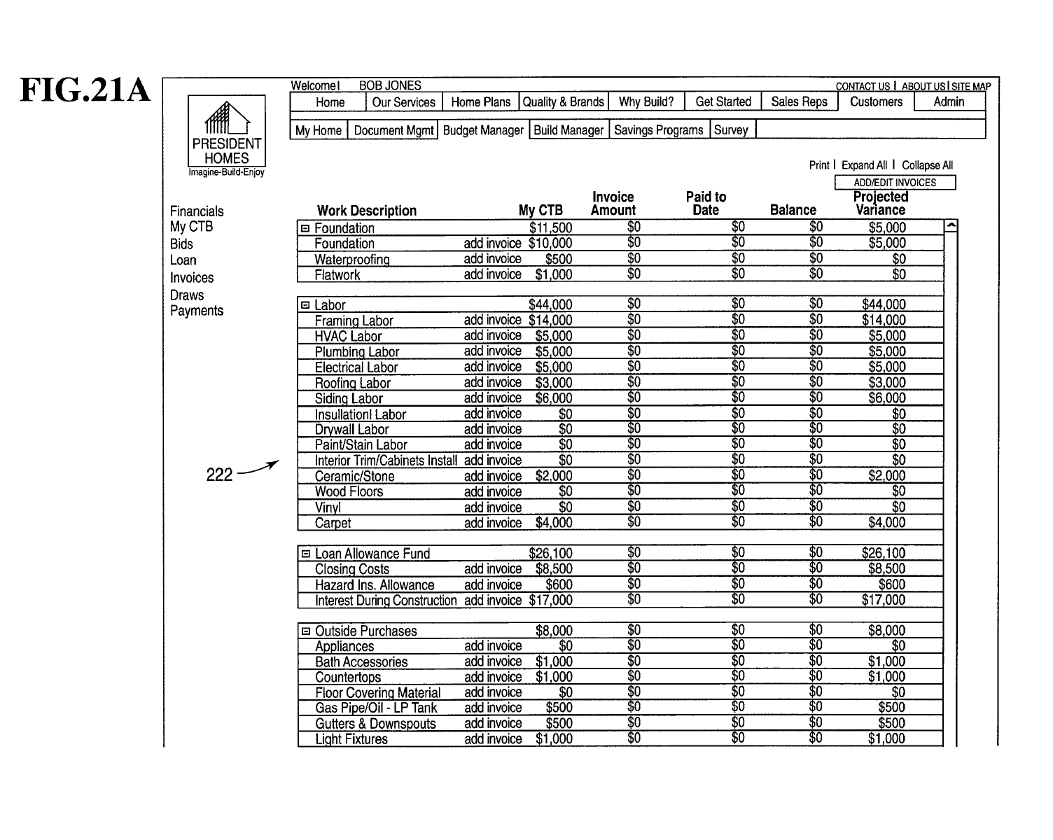

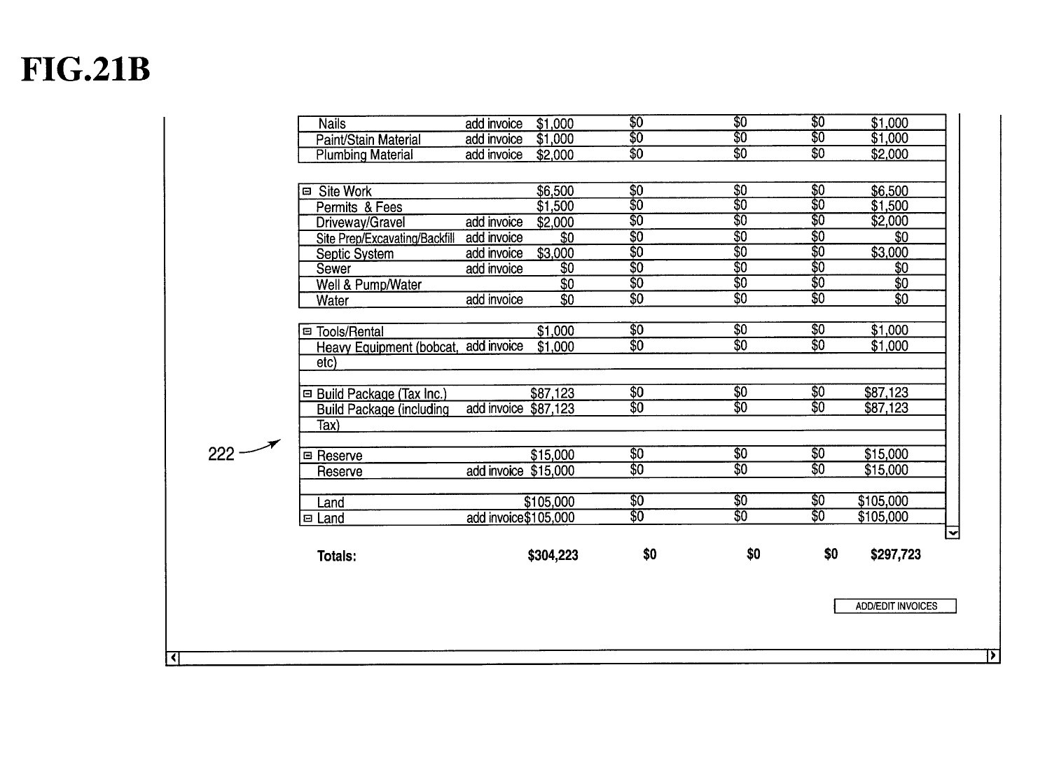

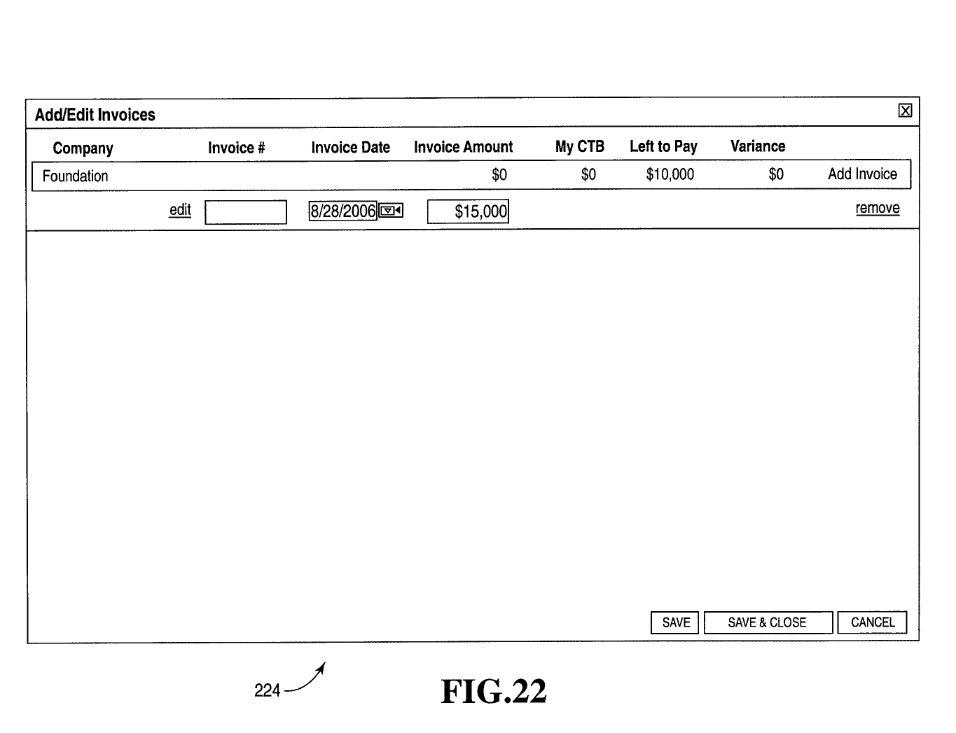

FIGS. 21A-21B illustrate a preferred embodiment of the Invoice Page 222 that is displayed upon selecting the Invoice tab 180. Through the Invoice Page 222, the Customer 60 preferably has the ability to enter invoices received from the Subcontractors during the Build Prep Stage 108, the Foundation Stage 110, the Build Stage 112 and Finish Stage 114 stage. Thus, the Customer 60 has the ability to track all invoices received, payments made and any outstanding balances for each work item. An advantage of the Invoice Page 222 is that it permits the Customer to easily identify if the Subcontractors invoices are approaching or exceeding the Subcontractors original quotes. FIG. 22 is an example of a preferred template 224 for entering an invoice into the Invoice Page 222. The “Add Invoice Template” 224 of FIG. 22 preferably opens upon the Customer clicking the “add invoice” link corresponding to each work item on the Invoice Page 222. Through the template 224, the Customer can preferably enter the invoice number, the invoice date, and the invoice amount. The Program 14 preferably calculates and displays the difference between the dollar value bid or estimated for the work item under the My CTB field and the amount of the invoices entered.

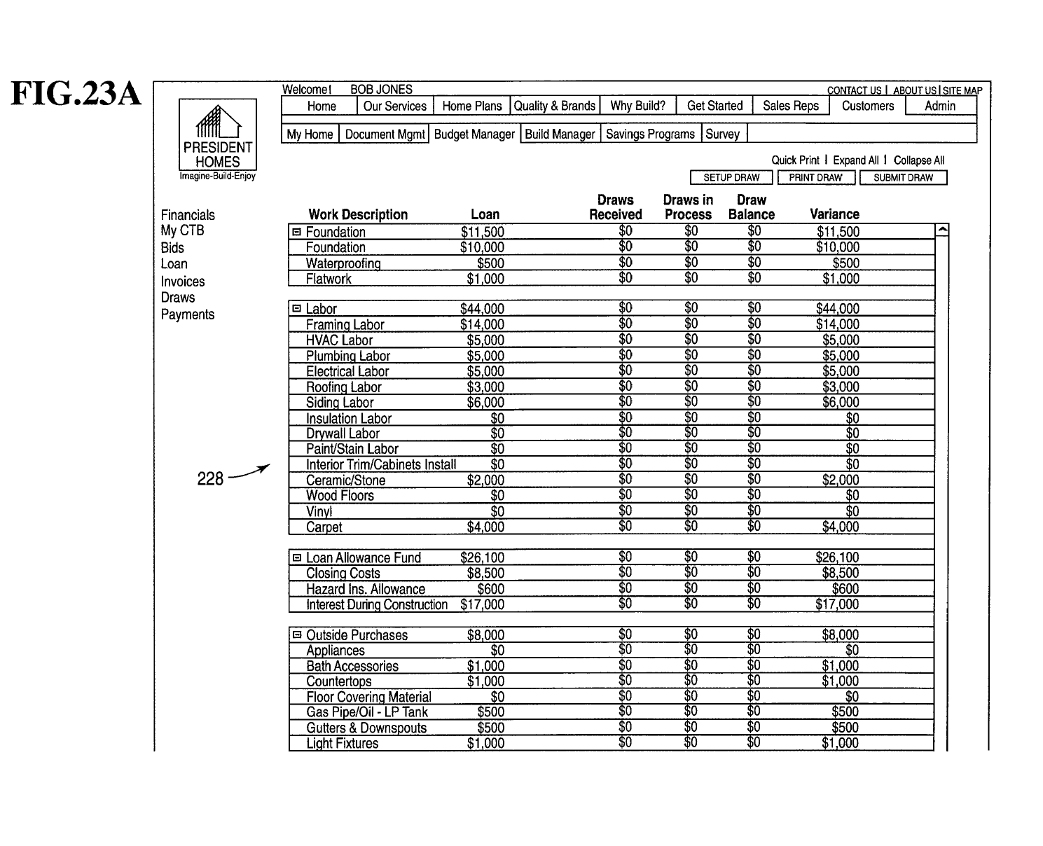

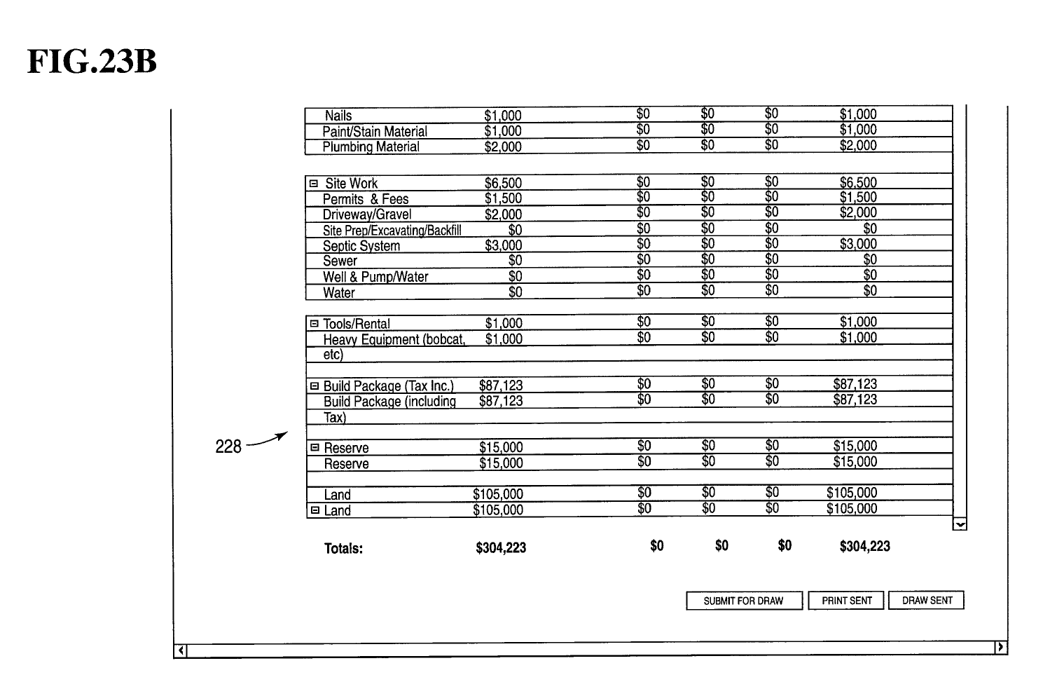

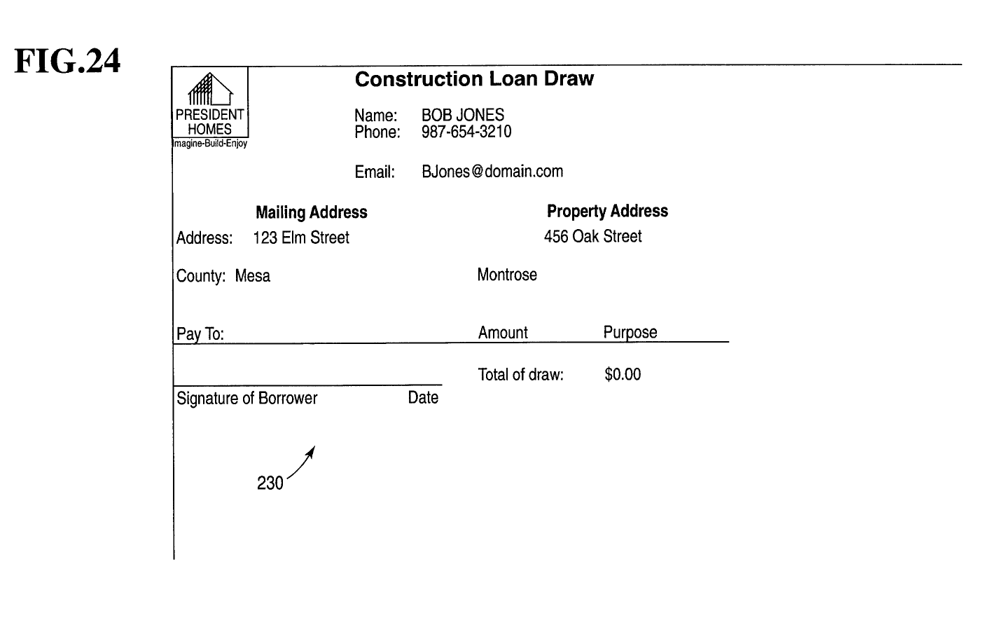

FIGS. 23A-23B illustrate a preferred embodiment of the Draws Page 228 that is displayed upon selecting the Draws tab 182 under the Budget Manager. Through this Draws Page 228, the Customer 60 preferably has the ability to record the draws submitted to the Lender (which the Lender applies against the construction loan) for payment to Subcontractors 32, Suppliers 28 or others against invoices received for a particular work item. This functionality allows the Customer 60 to track the dollar amount of all draws received from the Lender corresponding to a particular work item, the dollar amount of any draws requested but not yet received, the draw total (i.e., the amount of the draws requested and in process), and the variance between the loan amount and the draw total. The Draws Page 228 preferably includes a button that, when clicked, opens a Create A Draw Template 230 (FIG. 24) which allows the Customer to enter the payee information, the amount, and the purpose of the draw. Preferably, the Program 14 automatically populates the draw with the name and contact information of the Customer/Borrower 60 and the Customer/Borrower's current mailing address and the property address for which the construction loan was obtained. Additionally, the Draw Page 228 preferably includes a button that enables the Customer to print the draws created for submitting to the Lender. Alternatively, or in addition, the Draw Page 228 may enable the Customer to generate and submit the draw request via email to the Lender.

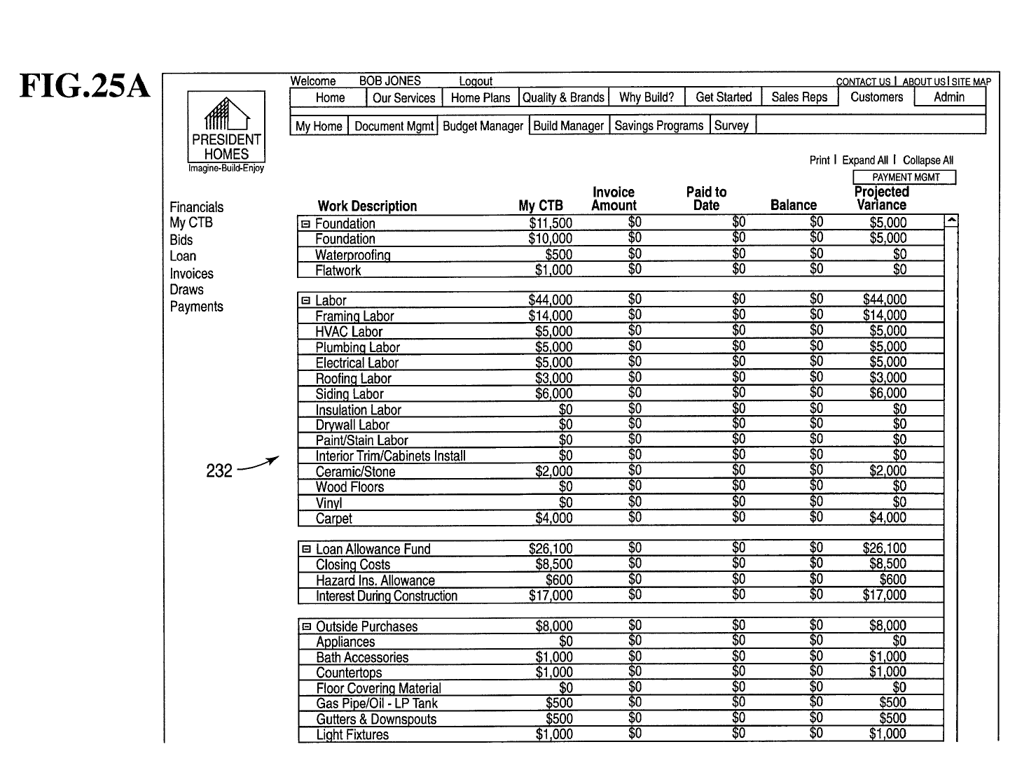

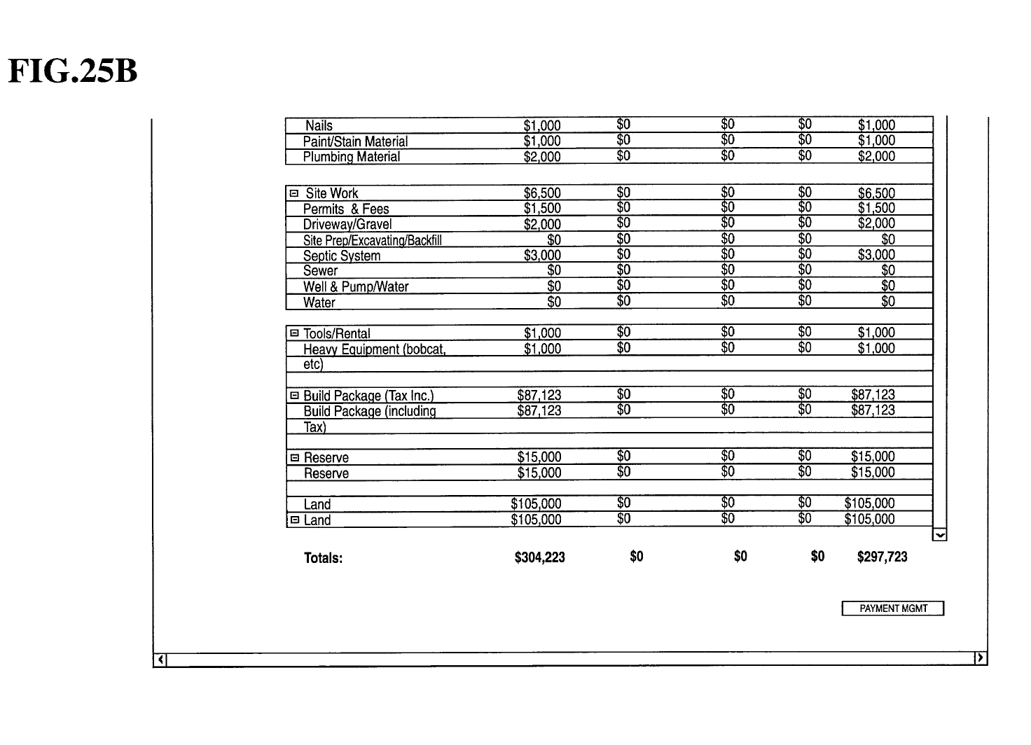

FIGS. 25A-25B illustrate a preferred embodiment of the Payments Page 232 that is displayed upon selecting the Payments tab 184 under the Budget Manager. Through the Payments Page 232, the Customer 60 preferably has the ability to record the payments made on any invoices received from Subcontractors 32, Suppliers 28 or others. Thus, through the Payments page 232 the Customer has the ability to track invoice amounts, the date the invoice was paid and the outstanding balance of any invoices. Through this page the Customer 60 can also track whether the invoices and payments made exceed the quotes or estimates shown in the My CTB field. It should be appreciated that the Invoice Amount on the Payments template is the populate with the same data corresponding to the invoice amount on the Invoice Page 232.

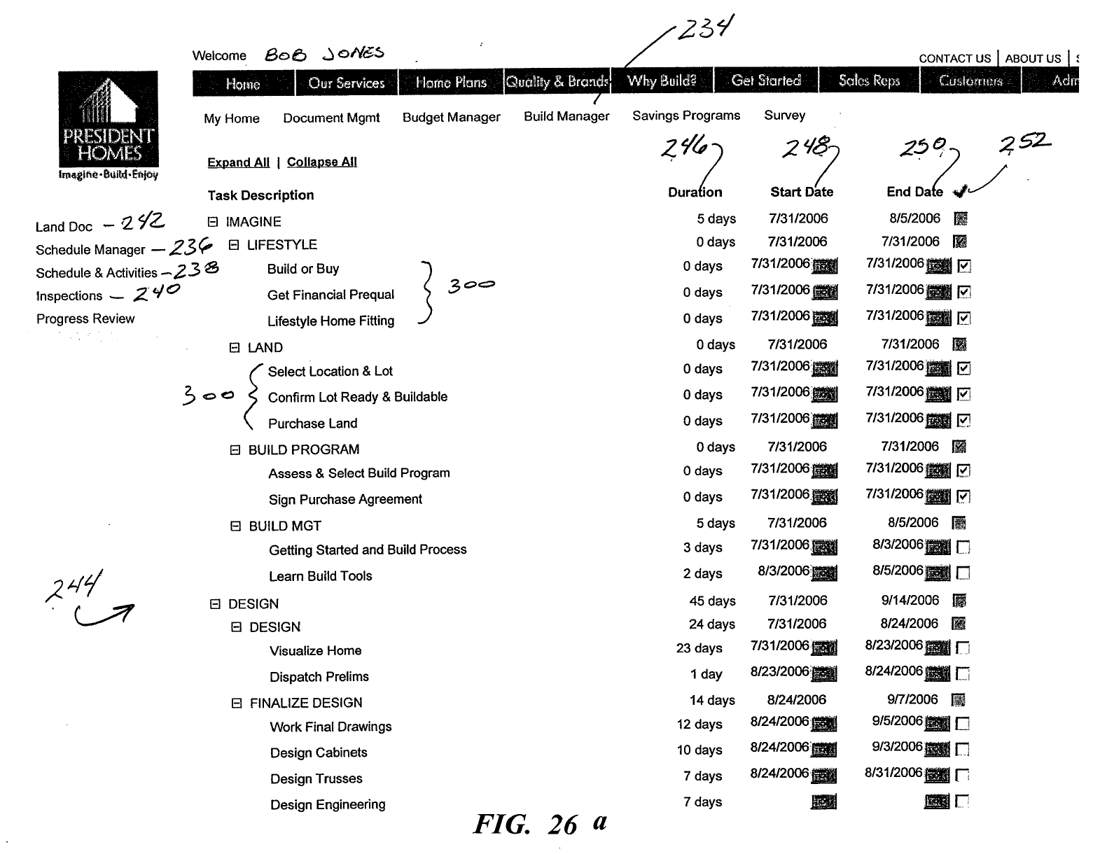

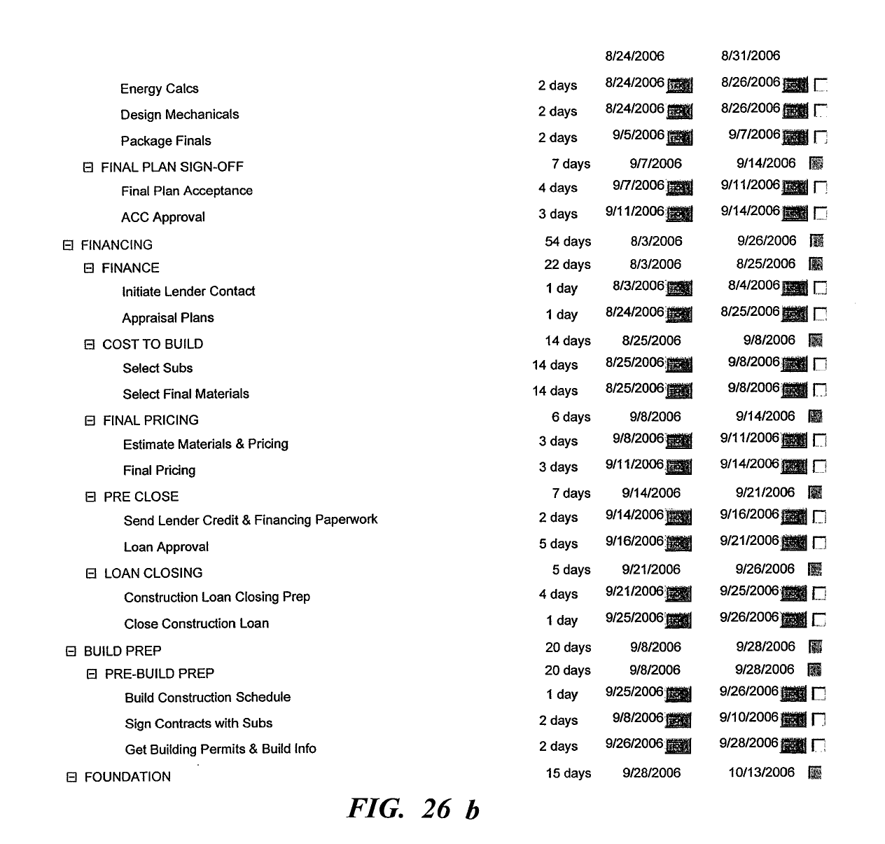

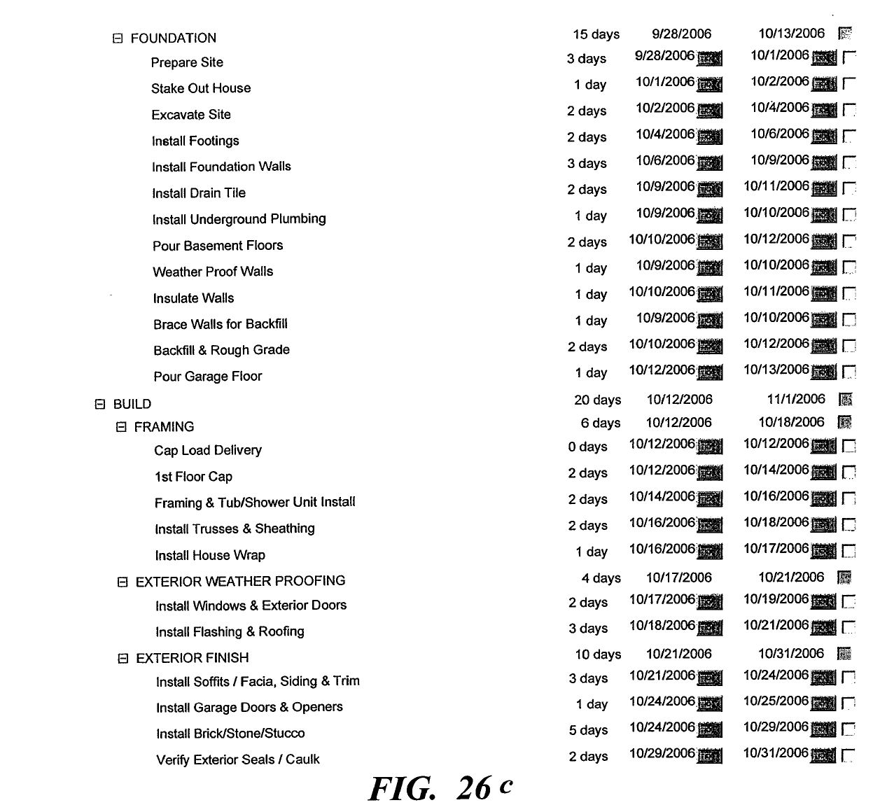

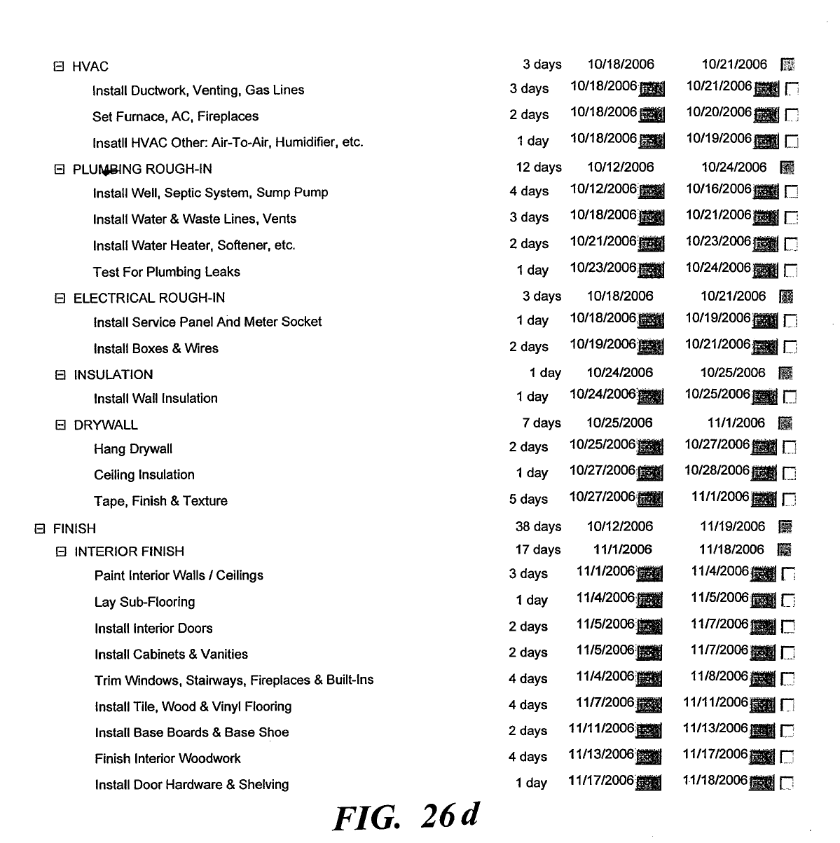

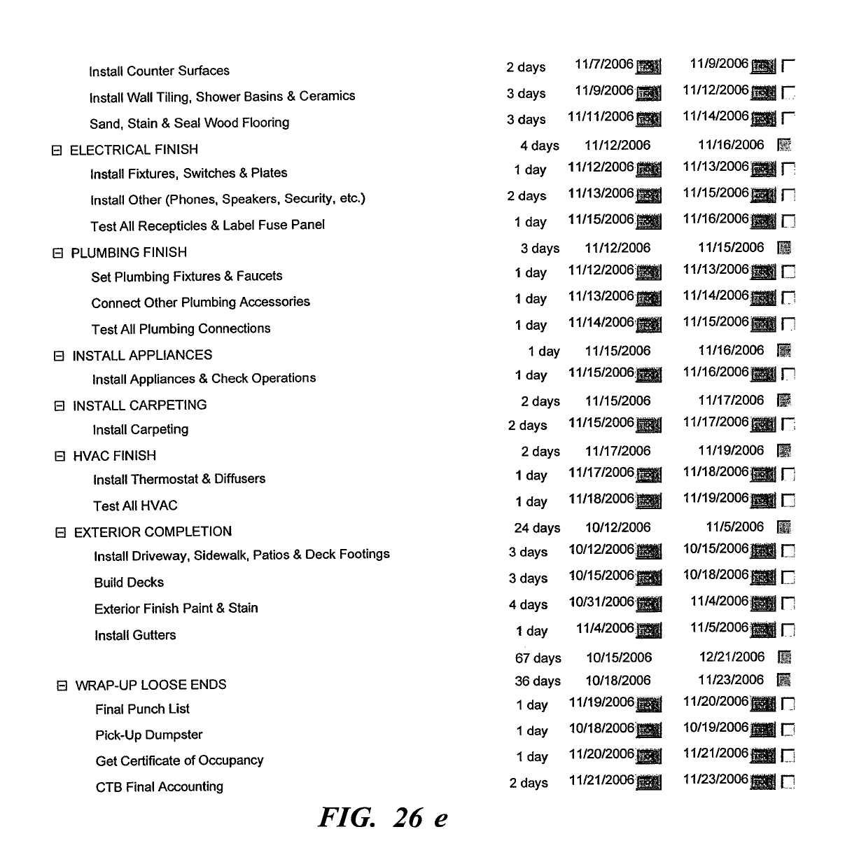

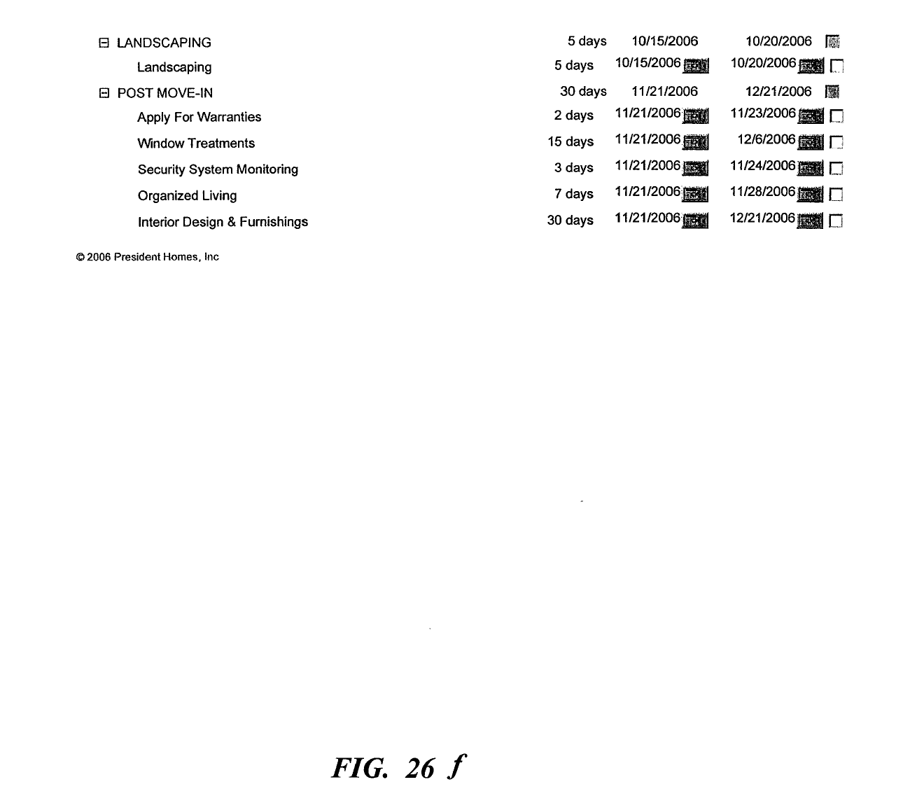

Examples of the preferred features and functionalities of the Build Manager are illustrated in FIGS. 26-28. Preferably both the Customer 60 and the Sales Rep 40 have access to the Build Manager. The Build Manager is preferably accessible by the Sales Rep by selecting the “Customers” tab 170 through the Sales Rep Homepage 126 (FIG. 7A). For the Customer, the Build Manager is preferably accessible after the Customer logs in to the website by selecting the “Build Manager” tab 234 on the Customer Homepage. Under the Build Manager, a number of left side navigation tabs 236-242 are preferably provided as illustrated in FIG. 26A.

FIGS. 26A-26F illustrate a preferred embodiment of the Schedule Manager Page 244 that is displayed upon selecting the “Schedule Manager” tab 236. The Schedule Manager Page 244 identifies the various predefined tasks 300 for each of the previously identified stages beginning with the Imagine Stage 102 through the Finish Stage 114. The Schedule Manager Page 244 also displays a Start Date field 246, an End Date field 248, a Duration field 250 and a Check Box field 252 for each of the Tasks 300. The Customer 60 and the Sales Rep 40 preferably set an initial schedule for each of the Tasks 300. In the preferred embodiment, only one of the dates (start or end) needs to be specified and the Program automatically sets the other date by counting forward or backward the appropriate days based on predetermined number of days anticipated to complete each Task based on past experience. Upon completion of an Activity 302, the Customer may put a check in the Check Box field 252 to indicate that the Activity has been completed. Preferably, upon completing all Activities 302 under a Task 300, the Program 14 automatically checks the Task as being complete. Additionally, the Program 14 preferably prevents a Task 300 from being checked complete until all Activities 302 associated with the Task 300 are checked off as complete.

FIGS. 27A-27S illustrate a preferred embodiment of the Schedule & Activities Page 254 that is displayed upon selecting the “Schedule & Activities” tab 238. The Schedule & Activities Page 254 also identifies the various predefined tasks 300 for each of the previously identified stages beginning with the Imagine Stage 102 through the Finish Stage 114. In addition, the Schedule & Activities Page 254 also lists predefined Activities 302 that are required to complete each Task 300. Additionally, the Schedule & Activities Page 254 displays the Start Date field 256, an End Date field 258 and the Duration field 260 for each of the Tasks 300 and Activities 302. As previously discussed, in the preferred embodiment, the Program 14 preferably automatically generates a start date based upon selection of an end date for a particular Task and/or Activity or vice-versa. It should be understood that in order to complete certain Tasks 300 other dependent Tasks and Activities may need to be completed first. For example the Framing Tasks (FIG. 27G) cannot begin until all the Foundation Tasks (FIG. 27E-27F are completed. Thus, the Program 14 preferably automatically changes the dates of any Tasks or Activities that are dependent upon other Tasks or Activities that the Customer/Sales Rep may change during the various stages of the construction process.

If the Customer changes a date the effects a Subcontractor, the Program 14 also preferably automatically sends out an email to notify the Subcontractor of the change in date. To help ensure that the Customer 60 does not fall too far behind in the schedule the Sales Rep 40 is preferably tasked to have period reviews with the Customer to check on the status the Customer's completion of the Tasks 300 and Activities 302.

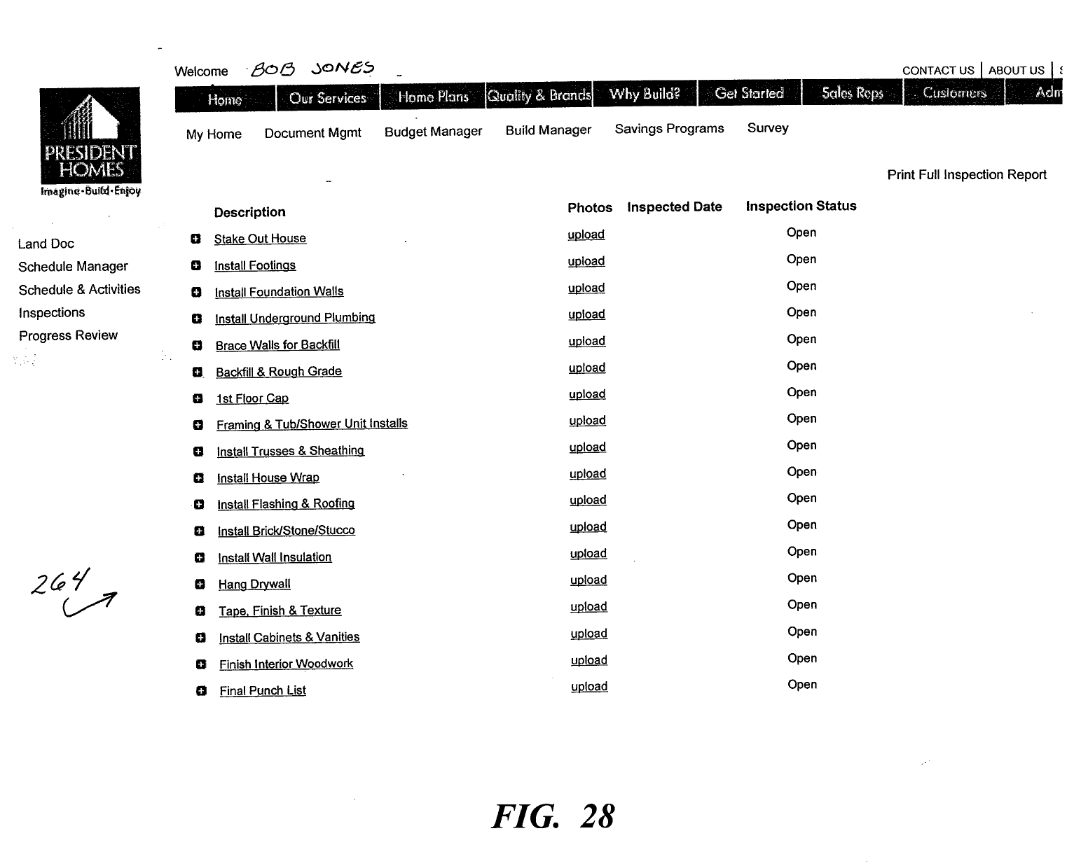

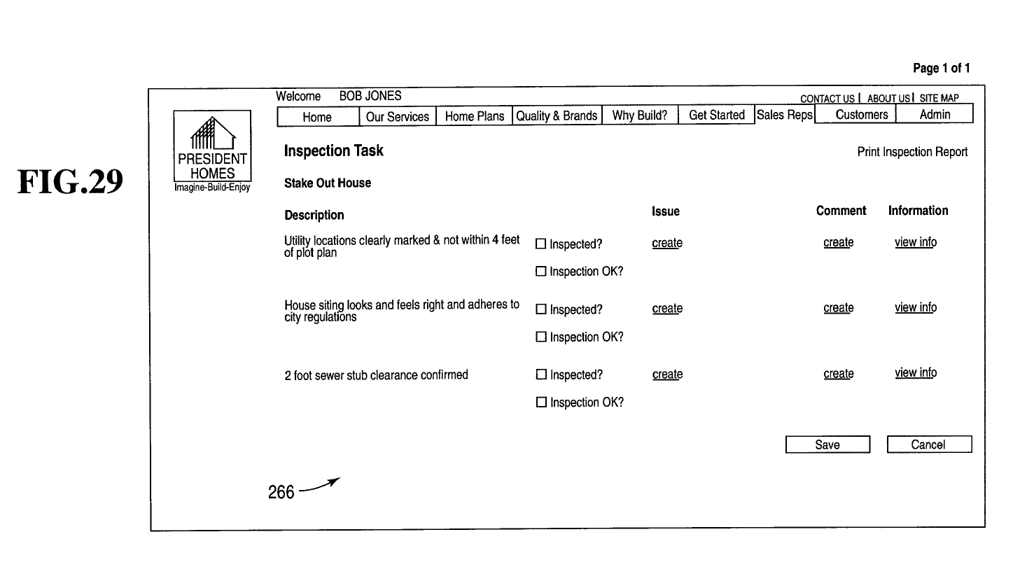

FIG. 28 illustrate a preferred embodiment of the Inspections Page 264 that is displayed upon selecting the “Inspections” tab 240. The Inspections Page 264 preferably contains a link to each work item that requires an inspection. Upon clicking the item link, the Program 14 preferably opens a separate Inspections Task Page 266 (FIG. 29) that allows the Customer to record whether the work item was inspected and whether the work item passed inspection. Additionally, the page preferably allows the Customer to make notes or comments concerning the inspection.

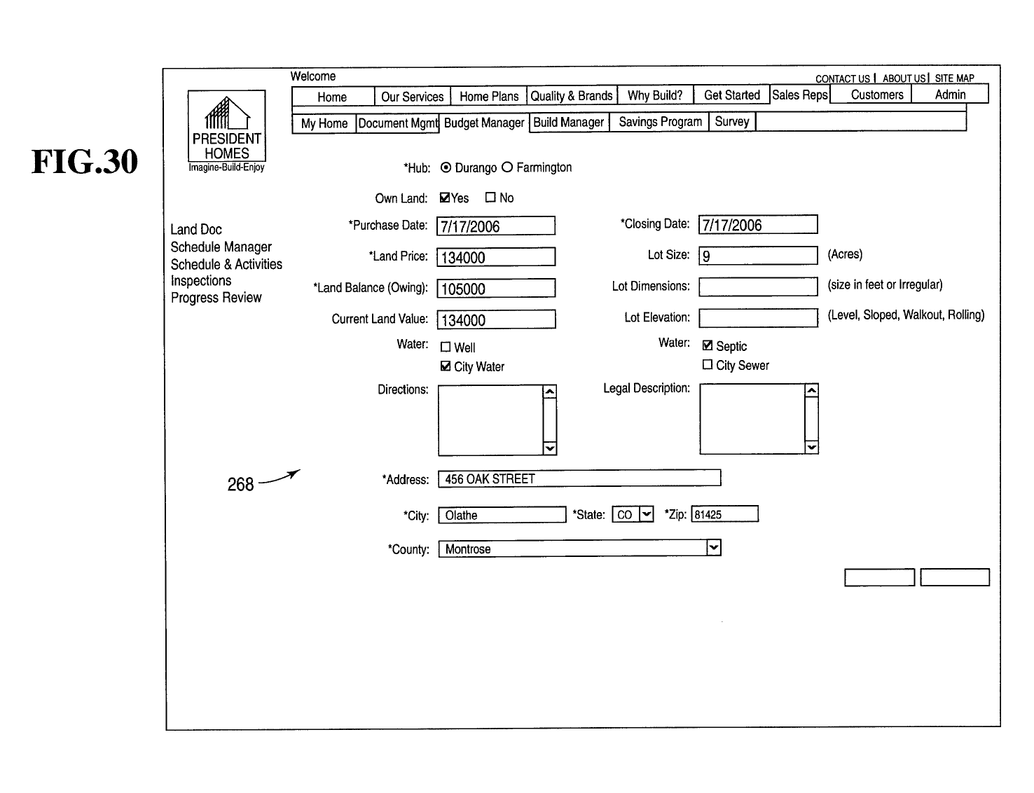

FIG. 30 illustrate a preferred embodiment of the Land Doc Page 268 that is displayed upon selecting the “Land Doc” tab 242. The Land Doc Page 268 preferably displays pertinent information concerning the Customer's land on which the home is to be built.

Although only an exemplary embodiment of the system and method of the present invention has been described in detail above, those skilled in the art will readily appreciate that many modifications are possible without materially departing from the novel teachings and advantages of this invention. Accordingly, all such modifications are intended to be included within the scope of the appended claims.

1. A method for assisting an individual in general contracting the construction of a home, said method comprising:
a) providing a Cost-To-Build (CTB) Template remotely accessible over a computer network, said CTB Template including a listing of options from which an individual desiring to general contract a home can select, said listing of options including predefined work items and predefined home amenities with corresponding fields populatable with typical costs based on geographic area;
b) selecting desired options from said listing of options, said selected options defining the individual's Build Package;
c) said CTB Template displaying an estimated cost to build said Build Package in a designated geographic area calculated based on a sum of said corresponding fields populated with typical costs for said designated geographic area.

2. The method of claim 1 wherein said corresponding populated fields can be overwritten with the individual's expected costs for said selected options.

3. The method of claim 3 wherein said listing of options includes predefined levels of sweat equity involvement of the individual.

4. The method of claim 3 wherein said listing of options includes predefined levels of assistance from an Advisor.

5. The method of claim 1 further comprising:
providing a Lender database comprising a pool of pre-approved Lenders from which the individual can select to obtain financing quotes;
obtaining financing quotes from said Lenders selected from said pool of Lenders, said financing quotes identifying financing for which the individual pre-qualifies.

6. The method of claim 1 further comprising:
providing an Advisor database comprising a pool of Advisors;
selecting an Advisor from said pool of Advisors to be assigned to the individual.

7. The method of claim 6 wherein said step of selecting an Advisor is based on said designated geographic area.

8. The method of claim 1 further comprising:
providing a Supplier database comprising a pool of pre-approved Suppliers from which the individual can select to obtain supplies for said Build Package;
obtaining Supplier quotes from Suppliers selected from said pool of Suppliers.

9. The method of claim 8 wherein said Suppliers comprising said pool of Suppliers are selectable based on materials supplied and geographic location.

10. The method of claim 1 further comprising:
providing a Realtors/Developers database comprising a pool of Realtors/Developers from which the individual can select for assistance in locating real estate on which to build;
obtaining prices for said real estate from said Realtors/Developers selected from said pool of Realtors/Developers.

11. The method of claim 10 wherein said Realtors/Developers comprising said pool of Realtors/Developers are selectable based on geographic location.

12. The method of claim 1 further comprising:
providing a Subcontractor database comprising a pool of Subcontractors from which the individual can select to obtain subcontracting services for said Build Package;
obtaining Subcontractor quotes from Subcontractors selected from said pool of Subcontractors.

13. The method of claim 12 wherein said Subcontractors comprising said pool of Subcontractors are selectable based on trade and geographic location.

14. The method of claim 8 further comprising:
providing a Realtors/Developers database comprising a pool of Realtors/Developers from which the individual can select for assistance in locating real estate on which to build;
obtaining prices for said real estate from said Realtors/Developers selected from said pool of Realtors/Developers.

15. The method of claim 14 further comprising:
providing a Subcontractor database comprising a pool of Subcontractors from which the individual can select to obtain subcontracting services for said Build Package;
obtaining Subcontractor quotes from Subcontractors selected from said pool of Subcontractors.

16. The method of claim 15 further comprising:
generating a purchase agreement based on said CTB estimate;
validating said purchase agreement by an Advisor confirming all said selected options defining said Build Package include an acceptable value.

17. The method of claim 16 further comprising:
providing a Budget Manager remotely accessible by the individual for inputting a selected real estate price, select Supplier quotes, and select Subcontractor quotes;
generating a loan document in a format previously approved by said Lenders for use in closing a construction loan for said Build Package.

18. The method of claim 17 wherein said Budget Manager further includes an invoice tracking template by which the individual can input invoices from said select Suppliers and said select Subcontractors for tracking actual costs in relation to said respective select Supplier quotes and said select Subcontractor quotes.

19. The method of claim 18 wherein said Budget Manager further includes a template to record draws for submitting to said select Lender for applying against said construction loan.

20. The method of claim 1 further comprising:
a Schedule Manager remotely accessible by the individual, said Schedule Manager populated with predefined tasks for completing said Build Package;
entering a desired completion date into said Schedule Manger for said Build Package, whereupon said Schedule Manager automatically populates a construction schedule with an initial schedule for said Build Package based on said desired completion date.

21. The method of claim 20 wherein, upon entry of a start date for certain of said predefined tasks that is different than a start date under said initial schedule, said Schedule Manager automatically adjusts said initial schedule to account for said different start date.

22. The method of claim 21 wherein, upon entry of a completion date for certain of said predefined tasks that is different than a completion date under said initial schedule, said Schedule Manager automatically adjusts said initial schedule to account for said different completion date.
